(19) United States
(12) Patent Application Publication
(10) Pub. No.: US 2026/0352284 A1
(43) Pub. Date: Nov. 5, 2026

(54) METHODS AND APPARATUSES FOR PROCESSING OF CHANNEL INFORMATION

(71) Applicant: Telefonaktiebolaget LM Ericsson (publ), Stockholm (SE)

(72) Inventors: Zhan ZHANG, Beijing (CN); Rakesh RANJAN, Järfälla (SE)

(21) Appl. No.: 19/124,703

(22) PCT Filed: Sep. 27, 2023
(86) PCT No.: PCT/CN2023/121969

§ 371 Date: Apr. 25, 2025

(30) Foreign Application Priority Data
Oct. 26, 2022 (WO) PCT/CN2022/127746

(51) Int. Cl. H04B 7/06; H04L 1/00; H04L 25/02

(52) U.S. Cl. CPC H04B 7/0626; H04B 7/0658; H04L 1/0026; H04L 25/0254

(57) ABSTRACT

Methods and apparatuses for processing of channel information are disclosed. According to an embodiment, a terminal device performs a configured group of predefined preprocessing from multiple predefined preprocessing. Each of the multiple A1 predefined preprocessing can determine, from channel information estimated by the terminal device, a different characteristic of the channel information. The terminal device performs a corresponding configured group of predefined encoding from multiple predefined encoding. Each of the multiple predefined encoding can compress the different characteristic of the channel information, based on an encoder portion of a machine learning (ML) model corresponding to the different characteristic. The terminal device transmits the compressed characteristics of the channel information to a network node. The network node performs a corresponding configured group of predefined decoding from multiple predefined decoding. Each of the multiple predefined decoding can decompress the compressed different characteristic of the channel information, based on a decoder portion of the same ML model corresponding to the different characteristic. The network node recovers the channel information from the decompressed characteristics of the channel information.

### TECHNICAL FIELD

Embodiments of the disclosure generally relate to communication, and more particularly, to methods and apparatuses for processing of channel information.

### BACKGROUND

This section introduces aspects that may facilitate better understanding of the present disclosure. Accordingly, the statements of this section are to be read in this light and are not to be understood as admissions about what is in the prior art or what is not in the prior art.

Machine learning (ML) models that do not assume about the form of mapping functions between the input(s) and output(s) are called non-parametric models. This gives them the freedom and power to learn any function from the training data.

Nowadays, whenever the 6th generation (6G) or future generation network is discussed, artificial intelligence (AI) such as ML based data driven solution is believed to be the most critical enabler of a lot of enhancements and is regarded as a key leverage to transform the whole design philosophy to a new level of adaptivity in diverse and distinct radio environments. Learning capability of AI creates advantageous policies or strategies directly based on data instead of human logics and symbolic or rule-based modeling and analysis. AI/ML enabled solutions essentially employ data-driven learning approaches where the models learn the underlying data distribution and relationship between the inputs and outputs without the need for understanding the underlying complex processes.

ML has been found to be an effective tool in physical layer design. For instance, the 3rd generation partnership project (3GPP) has now been investigating on channel information compression and reporting based on ML method.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for processing of channel information. In particular, one of the problems to be solved by the disclosure is that the single “universal” ML model used in the existing solution could not meet the requirements of channel state information (CSI) compression and feedback when the channel states become high-dimensional.

According to a first aspect of the disclosure, there is provided a method performed by a terminal device. The method may comprise performing a configured group of predefined preprocessing from multiple predefined preprocessing. Each of the multiple predefined preprocessing can determine, from channel information estimated by the terminal device, a different characteristic of the channel information. The method may further comprise performing a corresponding configured group of predefined encoding from multiple predefined encoding. Each of the multiple predefined encoding can compress the different characteristic of the channel information, based on an encoder portion of a machine learning (ML) model corresponding to the different characteristic. The method may further comprise transmitting the compressed characteristics of the channel information to a network node.

In this way, it is possible to reduce the complexity of compression of channel information.

In an embodiment of the disclosure, one of the different characteristics of the channel information may correspond to one of: frequency domain; space domain; space-frequency domain; different antenna polarization; different antenna sub-panel; gain part of the channel information; phase part of the channel information; different frequency sub-band; different beam; different beamforming scheme; and different accuracy or quantization scheme.

In an embodiment of the disclosure, the multiple predefined encoding may be configured so that one or more of the following are satisfied: one of the multiple predefined encoding uses a compression technique different than that used by another one of the multiple predefined encoding; one of the multiple predefined encoding has a frequency of reporting different than that of another one of the multiple predefined encoding; one of the multiple predefined encoding has an accuracy or quantization scheme different than that of another one of the multiple predefined encoding; and the ML model for at least one of the multiple predefined encoding is selectable from a teacher ML model and a configured group of student ML models of the teacher ML model.

In an embodiment of the disclosure, the method may further comprise selecting a configured group of predefined encoding from the multiple predefined encoding.

In an embodiment of the disclosure, the configured group of predefined encoding may be selected based on hardware capability of the terminal device.

In an embodiment of the disclosure, the method may further comprise transmitting information about the selected configured group of predefined encoding to the network node.

In an embodiment of the disclosure, the method may further comprise receiving, from the network node, information about the configured group of predefined encoding.

In an embodiment of the disclosure, the method may further comprise transmitting information about hardware capability of the terminal device to the network node.

In an embodiment of the disclosure, the information about the configured group of predefined encoding may comprise identifiers (IDs) of the ML models used for the configured group of predefined encoding.

In an embodiment of the disclosure, a first configuration about the multiple predefined preprocessing and/or a second configuration about the multiple predefined encoding may be preconfigured in the terminal device.

In an embodiment of the disclosure, the method may further comprise receiving, from the network node, a first configuration about the multiple predefined preprocessing and/or a second configuration about the multiple predefined encoding.

In an embodiment of the disclosure, the first configuration may comprise IDs of codebooks used for the multiple predefined preprocessing.

In an embodiment of the disclosure, the second configuration may comprise one or more of: input data types and formats for the multiple predefined encoding; output code types and formats for the multiple predefined encoding; reporting periods of encoded codes from the multiple predefined encoding; life-durations of the multiple predefined encoding; and metric for triggering refining of each of the multiple predefined encoding.

In an embodiment of the disclosure, the first configuration and/or the second configuration may be received via one or more of: radio resource control (RRC) signaling; and medium access control (MAC) signaling.

In an embodiment of the disclosure, the method may further comprise providing user data and forwarding the user data to a host computer via the transmission to the base station.

According to a second aspect of the disclosure, there is provided a method performed by a network node. The method may comprise receiving, from a terminal device, compressed characteristics of channel information which are compressed by performing a configured group of predefined encoding from multiple predefined encoding. The method may further comprise performing a corresponding configured group of predefined decoding from multiple predefined decoding. Each of the multiple predefined decoding can decompress a corresponding compressed characteristic of the channel information, based on a decoder portion of an ML model corresponding to the characteristic. The method may further comprise recovering the channel information from the decompressed characteristics of the channel information.

In this way, it is possible to reduce the complexity of decompression of channel information.

In an embodiment of the disclosure, one of the characteristics of the channel information may correspond to one of: frequency domain; space domain; space-frequency domain; different antenna polarization; different antenna sub-panel; gain part of the channel information; phase part of the channel information; different frequency sub-band; different beam; different beamforming scheme; and different accuracy or quantization scheme.

In an embodiment of the disclosure, the multiple predefined decoding may be configured so that one or more of the following are satisfied: one of the multiple predefined decoding uses a decompression technique different than that used by another one of the multiple predefined decoding; one of the multiple predefined decoding has a frequency of feedback reception different than that of another one of the multiple predefined decoding; one of the multiple predefined decoding has an accuracy or quantization scheme different than that of another one of the multiple predefined decoding; and the ML model for at least one of the multiple predefined decoding is selectable from a teacher ML model and a configured group of student ML models of the teacher ML model.

In an embodiment of the disclosure, the method may further comprise receiving information about the configured group of predefined encoding from the terminal device.

In an embodiment of the disclosure, the method may further comprise selecting a configured group of predefined encoding from the multiple predefined encoding.

In an embodiment of the disclosure, the configured group of predefined encoding may be selected based on one or more of: hardware capability of the terminal device; hardware capability of the network node; requirements of transmission scheme of the network node; required feedback quality of the channel information; link status between the network node and the terminal device; channel bands used between the network node and the terminal device; and mobility status of the terminal device.

In an embodiment of the disclosure, the method may further comprise transmitting information about the selected configured group of predefined encoding to the terminal device.

In an embodiment of the disclosure, the method may further comprise receiving information about hardware capability of the terminal device from the terminal device.

In an embodiment of the disclosure, the information about the configured group of predefined encoding may comprise IDs of the ML models used for the configured group of predefined encoding.

In an embodiment of the disclosure, the method may further comprise transmitting, to the terminal device, a first configuration about the multiple predefined preprocessing and/or a second configuration about the multiple predefined encoding.

In an embodiment of the disclosure, the first configuration may comprise IDs of codebooks used for the multiple predefined preprocessing.

In an embodiment of the disclosure, the second configuration may comprise one or more of: input data types and formats for the multiple predefined encoding; output code types and formats for the multiple predefined encoding; reporting periods of encoded codes from the multiple predefined encoding; life-durations of the multiple predefined encoding; and metric for triggering refining of each of the multiple predefined encoding.

In an embodiment of the disclosure, the first configuration and/or the second configuration may be transmitted via one or more of: RRC signaling; and MAC signaling.

According to a third aspect of the disclosure, there is provided a terminal device. The terminal device may comprise at least one processor and at least one memory. The at least one memory may contain instructions executable by the at least one processor, whereby the terminal device may be operative to perform a configured group of predefined preprocessing from multiple predefined preprocessing. Each of the multiple predefined preprocessing can determine, from channel information estimated by the terminal device, a different characteristic of the channel information. The terminal device may be further operative to perform a corresponding configured group of predefined encoding from multiple predefined encoding. Each of the multiple predefined encoding can compress the different characteristic of the channel information, based on an encoder portion of an ML model corresponding to the different characteristic. The terminal device may be further operative to transmit the compressed characteristics of the channel information to a network node.

In an embodiment of the disclosure, the terminal device may be operative to perform the method according to the above first aspect.

According to a fourth aspect of the disclosure, there is provided a network node. The network node may comprise at least one processor and at least one memory. The at least one memory may contain instructions executable by the at least one processor, whereby the network node may be operative to receive, from a terminal device, compressed characteristics of channel information which are compressed by performing a configured group of predefined encoding from multiple predefined encoding. The network node may be further operative to perform a corresponding configured group of predefined decoding from multiple predefined decoding. Each of the multiple predefined decoding can decompress a corresponding compressed characteristic of the channel information, based on a decoder portion of an ML model corresponding to the characteristic. The network node may be further operative to recover the channel information from the decompressed characteristics of the channel information.

In an embodiment of the disclosure, the network node may be operative to perform the method according to the above second aspect.

According to a fifth aspect of the disclosure, there is provided a computer program product. The computer program product may contain instructions which when executed by at least one processor, cause the at least one processor to perform the method according to any of the above first and second aspects.

According to a sixth aspect of the disclosure, there is provided a computer readable storage medium. The computer readable storage medium may store thereon instructions which when executed by at least one processor, cause the at least one processor to perform the method according to any of the above first and second aspects.

According to a seventh aspect of the disclosure, there is provided a terminal device. The terminal device may comprise a configured group of preprocessing components configured to perform a configured group of predefined preprocessing from multiple predefined preprocessing. Each of the multiple predefined preprocessing can determine, from channel information estimated by the terminal device, a different characteristic of the channel information. The terminal device may further comprise a configured group of sub-encoders configured to perform a corresponding configured group of predefined encoding from multiple predefined encoding. Each of the multiple predefined encoding can compress the different characteristic of the channel information, based on an encoder portion of an ML model corresponding to the different characteristic. The terminal device may further comprise a transmitter configured to transmit the compressed characteristics of the channel information to a network node.

According to an eighth aspect of the disclosure, there is provided a network node. The network node may comprise a receiver configured to receive, from a terminal device, compressed characteristics of channel information which are compressed by performing a configured group of predefined encoding from multiple predefined encoding. The network node may further comprise a configured group of sub-decoders configured to perform a corresponding configured group of predefined decoding from multiple predefined decoding. Each of the multiple predefined decoding can decompress a corresponding compressed characteristic of the channel information, based on a decoder portion of an ML model corresponding to the characteristic. The network node may further comprise a post-processing component configured to recover the channel information from the decompressed characteristics of the channel information.

According to a ninth aspect of the disclosure, there is provided a communication system. The communication system may comprise a terminal device and a network node. The terminal device may comprise a configured group of preprocessing components configured to perform a configured group of predefined preprocessing from multiple predefined preprocessing. Each of the multiple predefined preprocessing can determine, from channel information estimated by the terminal device, a different characteristic of the channel information. The terminal device may further comprise a configured group of sub-encoders configured to perform a corresponding configured group of predefined encoding from multiple predefined encoding. Each of the multiple predefined encoding can compress the different characteristic of the channel information, based on an encoder portion of an ML model corresponding to the different characteristic. The terminal device may further comprise a first transmitter configured to transmit the compressed characteristics of the channel information to the network node. The network node may comprise a first receiver configured to receive, from the terminal device, the compressed characteristics of the channel information. The network node may further comprise a configured group of sub-decoders configured to perform a corresponding configured group of predefined decoding from multiple predefined decoding. Each of the multiple predefined decoding can decompress the compressed different characteristic of the channel information, based on a decoder portion of the same ML model corresponding to the different characteristic. The network node may further comprise a post-processing component configured to recover the channel information from the decompressed characteristics of the channel information.

In an embodiment of the disclosure, one of the different characteristics of the channel information may correspond to one of: frequency domain; space domain; space-frequency domain; different antenna polarization; different antenna sub-panel; gain part of the channel information; phase part of the channel information; different frequency sub-band; different beam; different beamforming scheme; and different accuracy or quantization scheme.

In an embodiment of the disclosure, the multiple predefined encoding may be configured so that one or more of the following are satisfied: one of the multiple predefined encoding uses a compression technique different than that used by another one of the multiple predefined encoding; one of the multiple predefined encoding has a frequency of reporting different than that of another one of the multiple predefined encoding; one of the multiple predefined encoding has an accuracy or quantization scheme different than that of another one of the multiple predefined encoding; and the ML model used for at least one of the multiple predefined encoding is selectable from a teacher ML model and a configured group of student ML models of the teacher ML model.

In an embodiment of the disclosure, the multiple predefined decoding may be configured so that one or more of the following are satisfied: one of the multiple predefined decoding uses a decompression technique different than that used by another one of the multiple predefined decoding; one of the multiple predefined decoding has a frequency of feedback reception different than that of another one of the multiple predefined decoding; one of the multiple predefined decoding has an accuracy or quantization scheme different than that of another one of the multiple predefined decoding; and the ML model used for at least one of the multiple predefined decoding is selectable from a teacher ML model and a configured group of student ML models of the teacher ML model.

In an embodiment of the disclosure, the terminal device may be configured to select a configured group of predefined encoding from the multiple predefined encoding.

In an embodiment of the disclosure, the configured group of predefined encoding may be selected based on hardware capability of the terminal device.

In an embodiment of the disclosure, the first transmitter of the terminal device may be further configured to transmit information about the selected configured group of predefined encoding to the network node.

In an embodiment of the disclosure, the network node may be configured to select a configured group of predefined encoding from the multiple predefined encoding.

In an embodiment of the disclosure, the configured group of predefined encoding may be selected based on one or more of: hardware capability of the terminal device; hardware capability of the network node; requirements of transmission scheme of the network node; required feedback quality of the channel information; link status between the network node and the terminal device; channel bands used between the network node and the terminal device; and mobility status of the terminal device.

In an embodiment of the disclosure, the network node may further comprise a second transmitter configured to transmit information about the selected configured group of predefined encoding to the terminal device.

In an embodiment of the disclosure, the first transmitter of the terminal device may be further configured to transmit information about hardware capability of the terminal device to the network node.

In an embodiment of the disclosure, the information about the selected configured group of predefined encoding may comprise IDs of the ML models used for the selected configured group of predefined encoding.

In an embodiment of the disclosure, the network node may further comprise a second transmitter configured to transmit, to the terminal device, a first configuration about the multiple predefined preprocessing and/or a second configuration about the multiple predefined encoding. Or the first configuration and/or the second configuration may be preconfigured in the terminal device.

In an embodiment of the disclosure, the first configuration may comprise IDs of codebooks used for the multiple predefined preprocessing.

In an embodiment of the disclosure, the second configuration may comprise one or more of: input data types and formats for the multiple predefined encoding; output code types and formats for the multiple predefined encoding; reporting periods of encoded codes from the multiple predefined encoding; life-durations of the multiple predefined encoding; and metric for triggering refining of each of the multiple predefined encoding.

In an embodiment of the disclosure, the first configuration and/or the second configuration may be transmitted via one or more of: RRC signaling; and MAC signaling.

According to a tenth aspect of the disclosure, there is provided a method implemented in a communication system. The communication system may comprise a terminal device and a network node. The method may comprise, at the terminal device, performing a configured group of predefined preprocessing from multiple predefined preprocessing. Each of the multiple predefined preprocessing can determine, from channel information estimated by the terminal device, a different characteristic of the channel information. The method may further comprise, at the terminal device, performing a corresponding configured group of predefined encoding from multiple predefined encoding. Each of the multiple predefined encoding can compress the different characteristic of the channel information, based on an encoder portion of an ML model corresponding to the different characteristic. The method may further comprise, at the terminal device, transmitting the compressed characteristics of the channel information to the network node. The method may further comprise, at the network node, receiving, from the terminal device, the compressed characteristics of the channel information. The method may further comprise, at the network node, performing a corresponding configured group of predefined decoding from multiple predefined decoding. Each of the multiple predefined decoding can decompress the compressed different characteristic of the channel information, based on a decoder portion of the same ML model corresponding to the different characteristic. The method may further comprise, at the network node, recovering the channel information from the decompressed characteristics of the channel information.

According to an eleventh aspect of the disclosure, there is provided a method implemented in a communication system including a terminal device and a network node. The method may comprise all steps of the methods according to the above first and second aspects.

According to a twelfth aspect of the disclosure, there is provided a communication system. The communication system may comprise a terminal device according to the above third or seventh aspect and a network node according to the above fourth or eighth aspect.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating an existing solution for compression of CSI;

FIG. 2 is a diagram illustrating an exemplary scenario of radio propagation;

FIG. 3 is a diagram illustrating an embodiment of the disclosure;

FIG. 4 is a diagram illustrating another embodiment of the disclosure;

FIG. 5 is a diagram illustrating yet another embodiment of the disclosure;

FIG. 6 is a diagram illustrating yet another embodiment of the disclosure;

FIG. 7 is a diagram illustrating a communication system according to an embodiment of the disclosure;

FIG. 8 is a flowchart illustrating a method performed by a terminal device according to an embodiment of the disclosure;

FIG. 9 is a flowchart illustrating a method performed by a terminal device according to an embodiment of the disclosure;

FIG. 10 is a flowchart illustrating a method performed by a terminal device according to an embodiment of the disclosure;

FIG. 11 is a flowchart illustrating a method performed by a terminal device according to an embodiment of the disclosure;

FIG. 12 is a flowchart illustrating a method performed by a network node according to an embodiment of the disclosure;

FIG. 13 is a flowchart illustrating a method performed by a network node according to an embodiment of the disclosure;

FIG. 14 is a flowchart illustrating a method performed by a network node according to an embodiment of the disclosure;

FIG. 15 is a flowchart illustrating a method performed by a network node according to an embodiment of the disclosure;

FIG. 16 is a block diagram showing an apparatus suitable for use in practicing some embodiments of the disclosure;

FIG. 17 is a block diagram showing a terminal device according to an embodiment of the disclosure;

FIG. 18 is a block diagram showing a network node according to an embodiment of the disclosure;

FIG. 19 is diagram illustrating an example of a communication system in accordance with some embodiments;

FIG. 20 is a diagram illustrating a UE in accordance with some embodiments;

FIG. 21 is a diagram illustrating a network node in accordance with some embodiments;

FIG. 22 is a diagram illustrating a host in accordance with some embodiments;

FIG. 23 is a diagram illustrating a virtualization environment in which functions implemented by some embodiments may be virtualized;

FIG. 24 is a diagram illustrating a host communicating via a network node with a UE over a partially wireless connection in accordance with some embodiments;

FIG. 25 is a flowchart illustrating a method implemented in a communication system in accordance with some embodiments;

FIG. 26 is a flowchart illustrating a method implemented in a communication system in accordance with some embodiments;

FIG. 27 is a flowchart illustrating a method implemented in a communication system in accordance with some embodiments; and

FIG. 28 is a flowchart illustrating a method implemented in a communication system in accordance with some embodiments.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

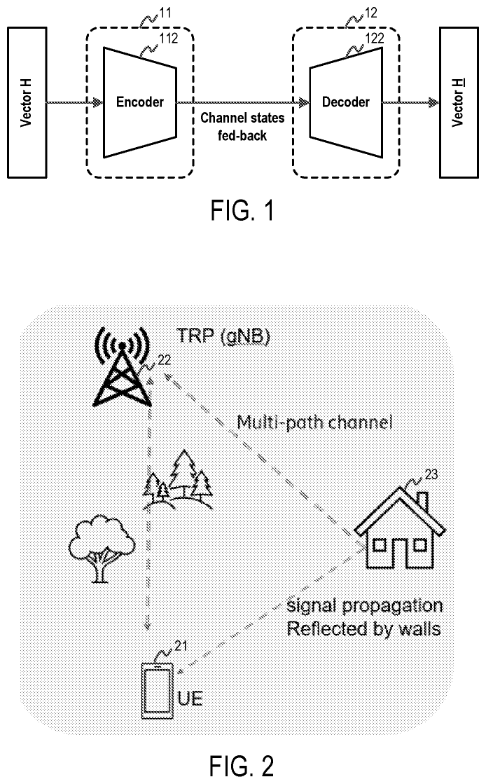

At 3GPP, in the current discussion, the channel state information (CSI) compression and feedback is on exploiting an autoencoder structure at R18 study item. FIG. 1 illustrates such autoencoder scheme for compressing CSI. As shown in FIG. 1, the CSI represented in the form of a vector H can be compressed by an encoder 112 in e.g. a user equipment (UE) 11 and be reported to e.g. a base station 12. The compressed CSI can be decompressed by a decoder 122 to a vector H.

FIG. 2 illustrates an exemplary scenario of radio propagation. As shown in FIG. 2, different radio propagations (e.g. the direct propagation from the transmission reception point (TRP) 22 to the UE 21, and the indirect propagation from the TRP 22 to the UE 21 via the reflection by the building 23) could result in quite different channel features, such as channel coherent bandwidth, channel variation over time and space.

At 3GPP, discussions at CSI and beam operation for Release-15 could be summarized as below. With respect to CSI, two different CSI types are supported in new radio (NR). Type-I is optimized for single user multiple-in multiple-out (MIMO) transmission with smaller uplink overhead. For Type-I, a terminal selects beam and co-phase (relative phase difference between X-pol antennas) coefficients. Type-II is optimized for multi-user MIMO transmission with finer channel information and as a consequence, larger uplink overhead. For Type-II, a terminal selects multiple beams, amplitude scaling, and phase coefficients for linear combination between the beams. With respect to multi-beam operation for initial access and data/control channel, there may be three stages. In the first stage, TRP level beam sweeping is performed for coverage. For example, the network can transmit synchronization signals and system information to the UE by transmission beam sweeping at the TRP. The network can receive a random access request from the UE by reception beam sweeping at the TRP. In the second stage, TRP and UE transmission/reception (TX/RX) beam acquisition is performed. For example, a random access response and other system information can be transmitted to the UE so that TX/RX beam can be acquired at the TRP/UE. In the third stage, UE specific beam selection and beamforming is performed. Specifically, communication can be performed on data/control channel between the network and the UE by UE specific beamforming over acquired TX/RX beams.

In 3GPP discussion, at Rel-16, the compression method for type II was further improved.

As aforementioned challenges, although ML based solution is superior at some cases in performance, the computing complexity could always be a challenge in commercial operations.

For instance, regarding the CSI compression and feedback, the radio air-interface has an increasingly large bandwidth and MIMO dimensions (large antenna arrays). The channel states become high-dimensional which, in machine learning based solutions, results in computational complexities. In other words, CSI of much higher dimensionality requires higher computing capacity for compression and recovery.

Additionally, different hardware constraints demand different transceiver implementation schemes to have distinct requirements on the CSI compression and feedback.

Hence, whenever a phenomenon or data is of a high dimension (with a large number of features), a single “universal” ML model will not meet the requirements unless it possesses a prohibiting complexity. How to train and adapt to different scenarios remains as a challenge and a straightforward single-model solution does not exist.

The present disclosure proposes an improved solution for processing of channel information. The solution may be applicable to a communication system including a terminal device and a network node (e.g. a base station). The terminal device can communicate through a radio access communication link with the base station. The base station can provide radio access communication links to terminal devices that are within its communication service cell. Note that the communications may be performed between the terminal device and the base station according to any suitable communication standards and protocols.

The term “terminal device” may also be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, the terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

The term “base station (BS)” may refer to, for example, a node B (NodeB or NB), an evolved Node B (eNodeB or eNB), a next generation Node B (gNodeB or gNB), a multi-standard radio (MSR) radio node such as an MSR BS, a master eNodeB (MeNB), a secondary eNodeB (SeNB), an integrated access backhaul (IAB) node, an access point (AP), a transmission point, a transmission reception point (TRP), a remote radio unit (RRU), a radio header (RH), a remote radio head (RRH), a relay, a low power node such as a femto, a pico, and so forth. For example, a base station may comprise a central unit (CU) and one or more distributed units (DUs). The CU and DU(s) may co-locate in a same network node, e.g. a same base station.

The improved solution of the present disclosure is mainly based on the consideration that because a single “universal” ML model cannot meet the requirements or if it does, it usually possesses a very prohibiting complexity, multiple ML models with quite different kinds of input/output and structures are needed for different needs, such as compression rates and different accuracy. In addition, a neural network of smaller size usually is much easier than that of a bigger size to be trained to have a suitable representation power for a sub-set of the data features. This also increases the interpretability of the model to ensure the reliability of the solution. Accordingly, a structured scheme is proposed by applying domain knowledge in the ML enabled CSI compression and feedback, in the form of a multiple-inference-nets-based solution, to well balance the performance and complexity.

One of the basic ideas is to utilize a predefined set of associated CSI compression encoder-decoder (inference-networks) to jointly work instead of a single large encoder-decoder. The associated sub-networks take different types of inputs, relevant to the CSI, and yield different codes for decoder to jointly recover the channel with multiple such codes. The sub-decoder has a matched structure as the sub-encoder. This sub-network set could fit different types of inputs well in terms of a higher ML efficiency or data representation power.

In other words, a new methodology is defined to create a set of encoders-decoders by characteristically splitting different properties of the channel information and thus compressing them separately. By utilizing domain expertise, such a splitting of functions facilitates a higher machine learning efficiency and effectiveness than a large function.

Another one of the basic ideas is to flexibly select and combine pre-trained sub-encoder-decoder (including specialized preprocessing for different inputs and post-processing) units to work for dynamic scenarios, which further enhances the flexibility in reducing the complexity.

Yet another one of the basic ideas is to outline new types of signaling and procedure needed for supporting the operations of such methods. Yet another one of the basic ideas is to split the channel information into different parts and compress the parts separately using different compression techniques. Yet another one of the basic ideas is to allow a series of ML models to be trained under a teacher-student fashion to fit into different needs at different complexity scenarios and link statuses.

The proposed solution could facilitate the reduction of CSI compression/reporting complexity in wide-band and large dimension MIMO and is suitable to fit different transmission schemes or hardware capabilities. It targets not only the computational complexity reduction, but also a higher feasibility/flexibility at operations in different scenarios by its configurable structure of multiple-sub-nets for different types of data. Thereby, the interpretability and reliability of the solution could be brought by this “divide and conquer” proposal. It can consolidate the basis of commercial use of ML method at next-generation RAN.

Hereinafter, several embodiments will be described to explain the solution of the present disclosure.

### Structured Set of Encoder-Decoder Sets to Jointly Recover the CSI

Firstly, it is proposed to utilize a structured set of associated CSI compression sub-encoder-decoder units to jointly work together instead of a single large encoder-decoder, to balance the complexity and performance.

The associated sub-inference networks may take different types of inputs relevant to the CSI and yield different codes for decoder to jointly recover the channel with multiple such codes. Correspondingly, the decoder has a matched structure as the encoder. As different types of data have different features in distributions, so for each of different input types, a suitable sub-inference-network is necessary for suitable representation power and machine learning efficiency and performance.

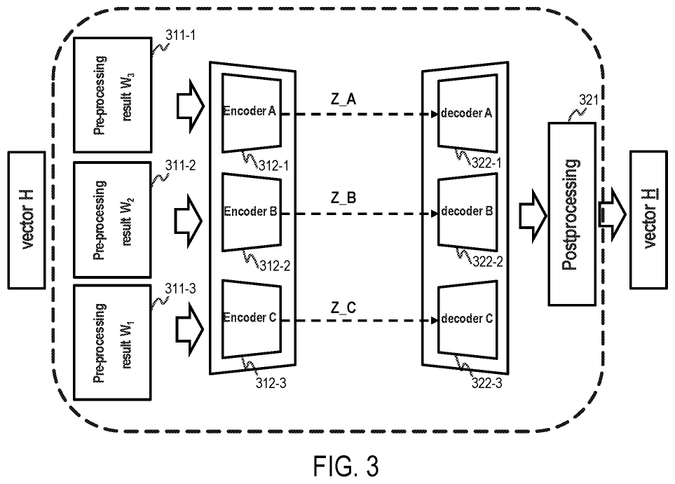

FIG. 3 illustrates an embodiment in which a set of auto-encoders are used to form an encoder-decoder pair. As illustrated in FIG. 3, the channel state information H firstly goes into preprocessing 311-1, 311-2 and 311-3 to obtain CSI relevant vectors (matrices) w₁, w₂, w₃ to build reported CSI f(w₁, w₂, w₃), where f is a known function, for instance H=[w₁, w₂] w₃. For example, assuming raw channel status for a MIMO channel is Hᵢ at i^{th} subcarrier in a physical resource block (PRB), preprocessing includes calculating R=ΣᵢHᵢ^{H}Hᵢ. Then after singular value decomposition (SVD), R=USU^{H} where superscript ^{H} stands for complex conjugate transpose. The CSI needed for beamforming at transmission/reception point (TRP of gNB) could be only (Uw₃)^{H} where w₃ is a square root of diagonal matrix S=diag ([s₁, s₂]) and U=[w₁, w₂] . Then the multiple sub-encoders 312-1, 312-2, 312-3 and sub-decoders 322-1, 322-2, 322-3 separately work for these different types of matrices individually. The different vectors (matrices) of data have quite different coherence time and/or different distributions, so that same or different sub-encoder-decoder(s) are required to be trained and utilized in a structured way as illustrated in FIG. 3. This structure can be configured and utilized to form a complete auto-encoder for link CSI compression and reporting. Code Z_A stands for latent coefficients for W₃, code Z_B represents that for W₂, and Code Z_C represents that for W₁. As an extension of this example, if Hᵢ=[H_{i[p0]}, H_{i[p1]}] where p0 stands for one polarization array of antennas and p1 stands for another, then R_{[p0]}=Σᵢ(H_{i[p0]})^{H}H_{i[p0]}, R_{[p1]}=Σᵢ(H_{i[p1]})^{H}H_{i[p1]}. Hence, accordingly, U_{[p0]}w_{[p0]3} and U_{[p1]}w_{[p1]3} could be separately reported and preprocessed for different pairs of encoder and decoder, and at the receiver side, CSI could be recovered by joining the reported CSI.

At both sides of the encoder and decoder, either the sub-encoder and/or the sub-decoder individually works to output its result. At the encoder side, for each of sub-encoders, a pre-processing of H may be specified and done to get a compression matrix out of the original H. Each resulting compression matrix may be separately input to each corresponding encoder. Then at decoder side, the outputs of sub-decoders are input to a post-processing 321 to recover the CSI eventually. Complexity and structure of each sub-encoder-decoder will be different as their data are of different types. A thorough training on its type of their inputs is necessary.

Note that the present disclosure is not limited to the example of decomposing the CSI into the 3 mapping matrices as illustrated in FIG. 3. As another example, the decomposition could be done regarding different antenna polarizations and different antenna sub-panels, and connection mapping matrix(es) among them by exploiting domain knowledge. Though the aforementioned exemplified function was defined with a certain formula or fashion. This fashion is not a unique one for the preprocessing (pre-compression method) discussed in this disclosure. There could be quite different pre-processing methods to be defined and so are the corresponding sub-encoder-decoders.

As yet another example, the pre-compression could obtain gain part and phase part of channel information H separately and create different sub-encoders & sub-decoders to separately compress the gain part or phase part.

As yet another example, the preprocessing could try to get spatial features such as beams and delta channel changes over frequency sub-bands and utilize different sub-encoder-decoder for each of such featured inputs and outputs. With proper post-processing, at the decoder side, the full CSI could be recovered.

Different sub-encoder encoded codes could be configured with different frequencies of reporting, such as relatively long period vs. short period reports, depending on the physical features of channel representations.

Different sub-encoder-decoder and preprocessing & post-processing could be set with different accuracies or quantization schemes.

Note that such different mapping matrices, capturing the features in different domains have quite different variational rates over time/subframes (different coherent time), or different accuracies at the CSI data point. Then the subnet does not need to operate/update the code at the same pace. This in some sense increases the possibility to further reduce the feedback load by feeding back different compression results according to their coherence time.

In other words, this structure enables an individual training process or method for each of them, which not only provides the learning efficiency, but also induces possible flexible configuration of the utilizing codes (Z_A or Z_B in FIG. 3). An example could be that a set of auto-encoders are used to form an encoder-decoder pair based on different measurement periods. For example, the measurement or updating periods for different codes could be different when the sub-nets jointly infer the compressed channel status. This offers a great flexibility to further save the reporting resources, by taking account of the coherence time of different codes or different types of inputs.

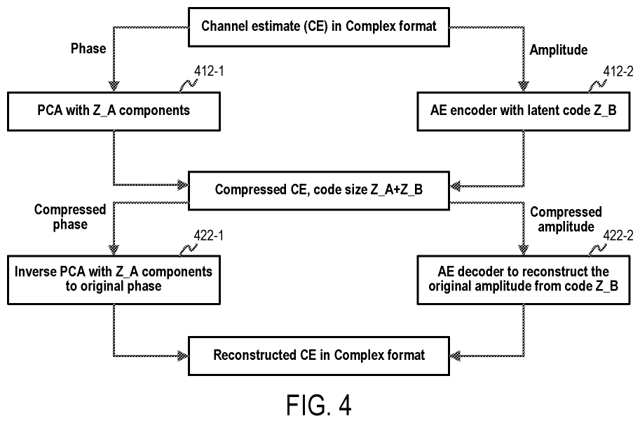

FIG. 4 illustrates another embodiment in which different compression techniques are used for compression of different parts of channel information. As shown, different parts of the channel (e.g., phase & amplitude) are extracted to be compressed via different compression methods (e.g., principal component analysis (PCA) & autoencoder (AE) respectively) by components 412-1 and 412-2. Then the compressed parts are decompressed by the components 422-1 and 422-2 using different decompression techniques respectively.

In this embodiment, it is proposed to perform compression of different parts/characteristics of channels using different techniques. For example, i) any feedforward model as an encoder (for the reduction of a part of CSI e.g. amplitude to a reduced code size) for the compression of channel estimate (CE), and a corresponding feedforward model as a decoder (reconstruction of the original amplitude in CSI), and ii) a model which uses another technique for example a linear model (e.g., PCA) that compresses another part e.g. phase.

Here, the combination of non-linear and linear compression methods for amplitude and phase are merely illustrative and could be any combination of multiple techniques.

### Dynamically Configure/Select the Different Types of Data-Features & Corresponding Sub-Encoder-Decoder (Group)

The present disclosure also proposes flexibly configuring/selecting pre-processing and corresponding encoder-decoder units to work in a dynamic scenario. This meets the need of frequent training of encoder-decoder. For instance, the transmission scheme (including transmitter and receiver configuration) may be changed.

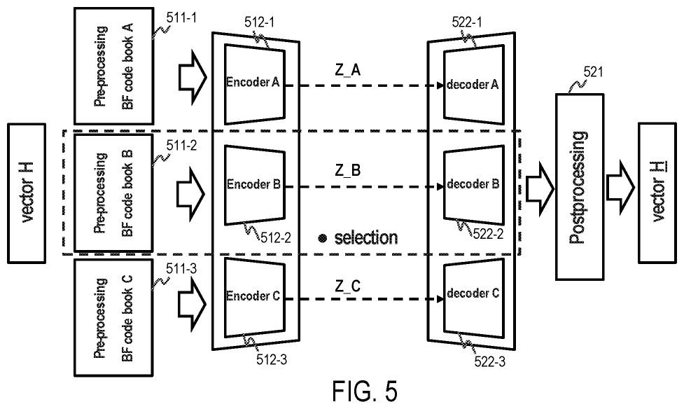

FIG. 5 illustrates an embodiment of a selection of pre-processing & corresponding encoder-decoder. As an example, raw CSI may be dimensionally compressed by a pre-defined codebook by the component 511-1 or 511-2 or 511-3 first. Then, these pre-processing results (such as CSI coordinates at a space spanning by different eigen-vectors of the codebook) may be further compressed by the auto-encoder method by the component 512-1 or 512-2 or 512-3. With different computing capabilities, the encoder side could select its suitable preprocessing method (such as beamforming (BF) code books) and corresponding sub-encoder-decoder pair to conduct the reporting of CSI. This selection could be done among a pre-configured set of codebooks as illustrated in FIG. 5. For instance, the code Z_A stands for the latent variable based on a codebook A based eigen-value vectors, while Z_B for codebook B and Z_C for codebook C. Then the code Z_B generated by the selected encoder B is decompressed by the corresponding decoder B. The post-processing 521 recovers the channel information H from the information decompressed by the decoder B.

Additionally, it is also possible for the UE (CSI reporter) to report its own formulated codebooks or pre-processing method (in terms of coefficients) together with (before) encoded codes. Given the updating of pre-processing method (codebook) needs to be done only once for each connection to a certain gNB/UE, it is feasible and flexible.

If the UE capability is not an issue, results of the multiple sub-encoders or sub-decoders could be reported to a gNB. Then, the gNB determines which result to be used for its downlink (DL) transmission, depending on its TX beamforming (BF) scheme choice, link status (operating point in term of signal to interference plus noise ratio (SINR)), UE mobility and channel bands.

Different hardware capability of UE or gNB either in computing capability or its BF capability (analogue/digital/hybrid BF) could be a reason or metric to select different sub-encoder. One example is that a group of encoder-decoders are available for selection based about hardware constraints of UE or gNBs. Such a group of encoder-decoder components may have a relatively gradually higher complexity and higher performance in recovery accuracy.

### Sub-Inference-Networks Function Work for the Same Task (Sub-Task) but with Different Performance and Complexity

In order to provide a higher level of flexibility or feasibility, a teacher-student training could be used. For example, UEs usually have rather distinct or limited computing resources. Hence, using the teacher-student method of training for a complex teacher model, one or several simpler student models could be trained for the same task with some compromise in accuracy. This could fit into different computing resources. Besides, the teacher model could be trained on all the features in the channel and the student models could only learn selected features. Using these trained simpler student models, each of them having learnt to compress one of different features could be put together for a more hardware cognitive CSI compression.

Teacher-student training in ML is a type of transfer learning in which a simpler model is trained for the same task with a slight performance trade-off. Typically, for CSI compression, the AE models that are designed are complex and with very high number of parameters. This could be a potential blocker for AE based CSI, as not all the devices have an endless amount of computing power.

The teacher-student training concept works well when it is desired to compress the model with not so huge hit in the performance. In the teacher step, a deep and complex AE with multiple layers could be trained to get the optimal compression with a latent code in smaller dimensions. The complex AE learns the underlying distribution of data and learns the optimal latent representation of the input CSI. Based on the trade-off of complexity reduction and accuracy, several student models could be created.

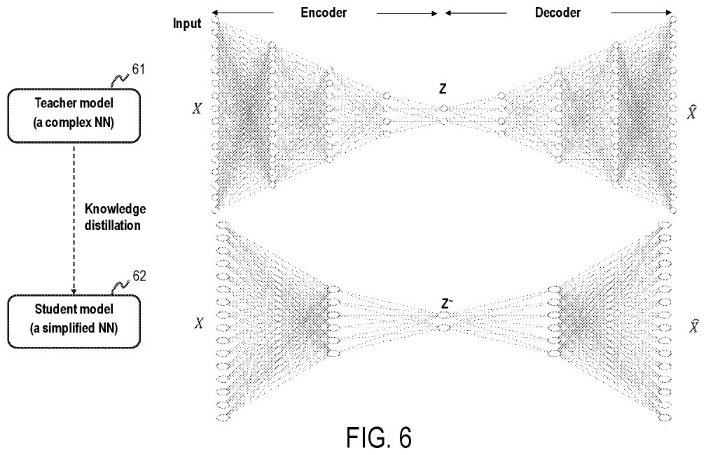

FIG. 6 illustrates an embodiment of teacher-student training where a very complex teacher AE could be trained for a simpler student AE. As shown, in the student step, a simpler model (e.g. a simplified neural network (NN)) 62 with much fewer layers is trained to replicate the function of the teacher model (e.g. a complex NN) 61. In this step, the student model 62 could also be trained on the target domain data if there is any deviation in it from the source-domain data that the teacher model has been trained on.

A selection may be made at the gNB or UE to best fit the context such as UE's computing capability and gNB's needs for different quality of CSI feedback depending on the different transmission scheme requirements.

### Signaling for Instruction and Configuration

At both sides of encoder and decoder (UE and gNB), the operation of CSI compression, reporting and recovering should be done synchronously in a sense that each pair of encoder-decoder should be pretrained to be matched ones at a certain time or frequency band.

Specifically, the gNB needs to properly configure a UE of the selected set or mode. The UE needs to follow the signaling specification to ensure the synchronous operation. In other words, both sides (gNB and UE) are aware of the feedback of codes based on which kind of sub-networks or input data types, so that a proper recovery of channel status could be carried out without mismatch.

The gNB may specify a different reporting period for each of feedback codes of a sub-encoder-decoder. Also, corresponding to this feature, pre-processing (pre-compression) and its post-processing may choose to use a historic code in recovering a full channel status H. In the signaling, such of content specifying the period, or different updating periods can be included.

As an indication of CSI computational craft as its capability, the UE may report its number of simultaneous CSI calculations called CSI processing units (CPUs). The BS could use this information along with the prevailing radio conditions to best match the complexity of models in the ML based CSI. If there are not enough CPUs available at the UE in the reporting, the BS could signal to use simpler models.

The aforementioned signaling may be added to either RRC layer or MAC layer if the NR or long term evolution (LTE) network supports the proposed solution. Dynamic and flexible configuration on UE and dynamic report formats are necessary and can be supported by the added signaling.

In general, the BS may signal the encoder model's ID that should be used for the CSI compression by the UE. The signaling may have the following fields to specify the UE actions: input data types and format; report code types and format; structure of sub-encoder/decoder pairs (or model ID); reporting periods of each encoded codes; life-duration of sub-encoder/decoder pairs; metrics to trigger refining of each of sub-encoder/decoder pairs; the selection of them out of many for a report; codebook ID for preprocessing; etc.

It should be noted that although the UE is described as the reporter of CSI and the base station is described as the receiver of CSI in the above description, the principle of the present disclosure is also applicable to the scenario where the base station is the reporter of CSI and the UE is the receiver of CSI.

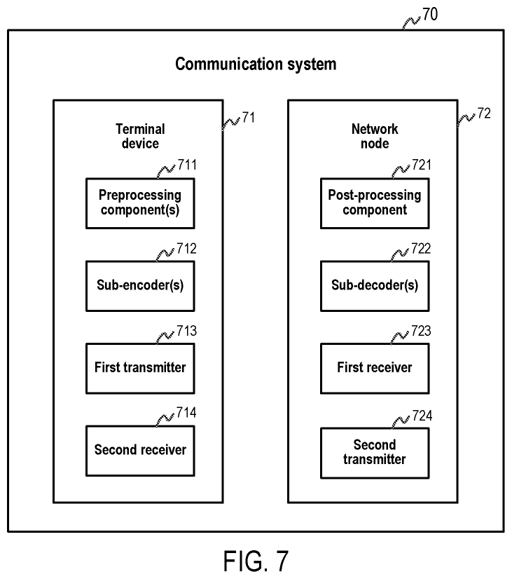

Hereinafter, the solution of the present disclosure will be further described with reference to FIGS. 7-28.

FIG. 7 is a diagram illustrating a communication system according to an embodiment of the disclosure. As shown, the communication system 70 comprises a terminal device 71 and a network node 72. The terminal device 71 at least comprises a configured group of preprocessing components 711, a configured group of sub-encoders 712, and a first transmitter 713. The network node 72 at least comprises a first receiver 723, a configured group of sub-decoders 722, and a post-processing component 721. Note that each of the number of the preprocessing components 711, the number of the sub-encoders 712, and the number of the sub-decoders 722 may be one or more than one.

The configured group of preprocessing components 711 are configured to perform a configured group of predefined preprocessing from multiple predefined preprocessing. Note that the number of the predefined preprocessing contained in the configured group may be one or more than one. Each of the multiple predefined preprocessing can determine, from channel information estimated by the terminal device, a different characteristic of the channel information. The channel information may refer to information which represents the state of a communication link between the network node (e.g. a base station) and the terminal device. In the present disclosure, the term “channel information” may be interchangeably used with the term “channel state information” or “channel status information”. One of the different characteristics of the channel information may correspond to one of: frequency domain; space domain; space-frequency domain; different antenna polarization; different antenna sub-panel; gain part of the channel information; phase part of the channel information; different frequency sub-band; different beam; different beamforming scheme; and different accuracy or quantization scheme.

As an example, the channel information represented in the form of a channel matrix may be preprocessed to be decomposed into a frequency compression matrix (corresponding to frequency domain), a space-frequency compression matrix (corresponding to space-frequency domain), and a spatial compression matrix (corresponding to space domain). As another example, the channel information represented in the form of a channel matrix may be preprocessed to be decomposed into different matrixes corresponding to different antenna polarizations (or different antenna sub-panels, or different frequency sub-bands, or different beams, or the like). As yet another example, the channel information may be preprocessed to be decomposed into gain part of the channel information and phase part of the channel information. As yet another example, depending on different beamforming schemes, different beamforming codebooks may be used in different preprocessing to generate different preprocessed results. As yet another example, different quantization schemes may be used in different preprocessing to generate different preprocessed results.

The configured group of sub-encoders 712 are configured to perform a corresponding configured group of predefined encoding from multiple predefined encoding. Note that the number of the predefined encoding contained in the configured group may be one or more than one. Each of the multiple predefined encoding can compress the different characteristic of the channel information, based on an encoder portion of an ML model corresponding to the different characteristic. For instance, for each of the different characteristics output from the multiple predefined preprocessing, a separate ML model containing a sub-encoder and a sub-decoder may be trained from actual experiment data or simulated data. The training may be performed in advance (at any suitable time) and the configuration about the ML model may be preset in the terminal device or signaled to the terminal device from the network. Since a separate ML model is trained for a different characteristic of the channel information, it is possible to reduce the complexity of compression of channel information.

As an example, one of the multiple predefined encoding may use a compression technique different than that used by another one of the multiple predefined encoding. As another example, one of the multiple predefined encoding may have a frequency of reporting different than that of another one of the multiple predefined encoding. As yet another example, one of the multiple predefined encoding may have an accuracy or quantization scheme different than that of another one of the multiple predefined encoding. As yet another example, the ML model used for at least one of the multiple predefined encoding is selectable from a teacher ML model and a configured group of student ML models of the teacher ML model. Note that the number of the student ML models may be one or more than one.

The first transmitter 713 is configured to transmit the compressed characteristics of the channel information (which are compressed by the configured group of sub-encoders 712) to the network node 72.

At the side of the network node 72, the first receiver 72 is configured to receive, from the terminal device, the compressed characteristics of the channel information.

The configured group of sub-decoders 722 are configured to perform a corresponding configured group of predefined decoding from multiple predefined decoding. Note that the number of the predefined decoding contained in the configured group may be one or more than one. Each of the multiple predefined decoding can decompress the compressed different characteristic of the channel information, based on a decoder portion of the same ML model corresponding to the different characteristic. Since a separate ML model is trained for a different characteristic of the channel information, it is possible to reduce the complexity of decompression of channel information. Corresponding to the sub-encoder side, as an example, one of the multiple predefined decoding may use a decompression technique different than that used by another one of the multiple predefined decoding. As another example, one of the multiple predefined decoding may have a frequency of feedback reception different than that of another one of the multiple predefined decoding. As yet another example, one of the multiple predefined decoding may have an accuracy or quantization scheme different than that of another one of the multiple predefined decoding. As yet another example, the ML model used for at least one of the multiple predefined decoding is selectable from a teacher ML model and a configured group of student ML models of the teacher ML model.

The post-processing component 721 may be configured to recover the channel information from the decompressed characteristics of the channel information. For example, the decompressed characteristics of the channel information may be combined to generate the recovered channel information. Such combining process may be inverse to the decomposition processes performed by the configured group of preprocessing components 711.

As a first option, the terminal device 71 may be configured to select a configured group of predefined encoding from the multiple predefined encoding. The configured group of predefined encoding may be selected based on hardware capability of the terminal device or any other suitable factors (e.g. required feedback quality of the channel information, channel bands used between the network node and the terminal device, mobility status of the terminal device, etc.). Due to the selection, the flexibility can be enhanced in the compression of the channel information to suit different application scenarios.

For the first option, the first transmitter of the terminal device may be further configured to transmit information about the selected configured group of predefined encoding to the network node. The information about the selected configured group of predefined encoding may comprise, but not limited to, IDs of the ML models used for the selected configured group of predefined encoding. Correspondingly, the first receiver 723 may be further configured to receive, from the terminal device 71, the information about the selected configured group of predefined encoding. A configured group of predefined decoding which corresponds to the configured group of predefined encoding indicated by the terminal device may be determined by the network node to be used for decoding, so that the encoding performed at the terminal device and the decoding performed at the network node can be matched with each other.

As a second option, the network node 72 may be configured to select a configured group of predefined encoding from the multiple predefined encoding. The configured group of predefined encoding may be selected based on one or more of: hardware capability of the terminal device; hardware capability of the network node; requirements of transmission scheme of the network node; required feedback quality of the channel information; link status between the network node and the terminal device; channel bands used between the network node and the terminal device; mobility status of the terminal device; etc. Due to the selection, the flexibility can be enhanced in the compression of the channel information to suit different application scenarios.

For the second option, the network node may further comprise a second transmitter 724 configured to transmit information about the selected configured group of predefined encoding to the terminal device. The information about the selected configured group of predefined encoding may comprise, but not limited to, IDs of the ML models used for the selected configured group of predefined encoding. Correspondingly, the terminal device 71 may further comprise a second receiver 714 configured to receive, from the network node 72, the information about the configured group of predefined encoding. For facilitating the selection made by the network node 72, the first transmitter 713 of the terminal device 71 may be further configured to transmit information about hardware capability of the terminal device 71 to the network node 72.

For both the above first and second options, the second transmitter 724 of the network node 72 may be configured to transmit, to the terminal device 71, a first configuration about the multiple predefined preprocessing and/or a second configuration about the multiple predefined encoding. Correspondingly, the second receiver 714 of the terminal device 71 may be configured to receive the first configuration and/or the second configuration from the network node 72. The first configuration may comprise, but not limited to, IDs of codebooks used for the multiple predefined preprocessing. The second configuration may comprise, but not limited to, one or more of: input data types and formats for the multiple predefined encoding; output code types and formats for the multiple predefined encoding; reporting periods of encoded codes from the multiple predefined encoding; life-durations of the multiple predefined encoding; and metric for triggering refining of each of the multiple predefined encoding. The first configuration and/or the second configuration may be transmitted via one or more of RRC signaling and MAC signaling. Alternatively, the first configuration and/or the second configuration may be preconfigured in the terminal device.

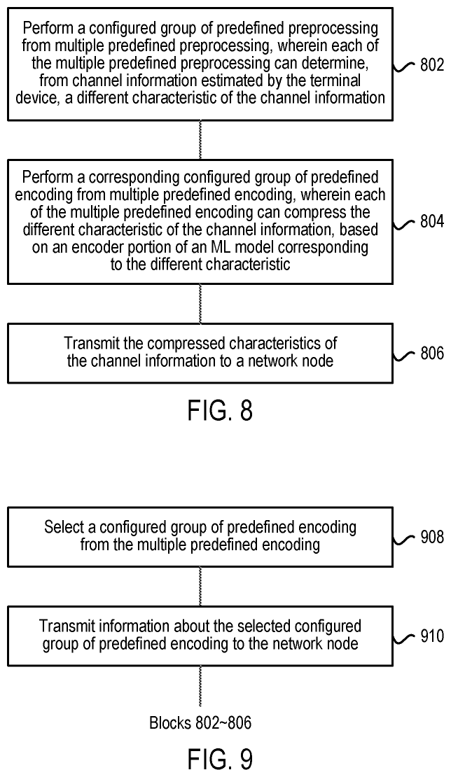

FIG. 8 is a flowchart illustrating a method performed by a terminal device according to an embodiment of the disclosure. At block 802, the terminal device performs a configured group of predefined preprocessing from multiple predefined preprocessing. Each of the multiple predefined preprocessing can determine, from channel information estimated by the terminal device, a different characteristic of the channel information. For example, one of the different characteristics of the channel information may correspond to one of: frequency domain; space domain; space-frequency domain; different antenna polarization; different antenna sub-panel; gain part of the channel information; phase part of the channel information; different frequency sub-band; different beam; different beamforming scheme; and different accuracy or quantization scheme.

At block 804, the terminal device performs a corresponding configured group of predefined encoding from multiple predefined encoding. Each of the multiple predefined encoding can compress the different characteristic of the channel information, based on an encoder portion of an ML model corresponding to the different characteristic. For instance, for each of the different characteristics output from the multiple predefined preprocessing, a separate ML model containing a sub-encoder and a sub-decoder may be trained from actual experiment data or simulated data. The training may be performed in advance (at any suitable time) and the obtained configuration about the ML model may be preconfigured in the terminal device or signaled to the terminal device from the network.

As an example, one of the multiple predefined encoding may use a compression technique different than that used by another one of the multiple predefined encoding. As another example, one of the multiple predefined encoding may have a frequency of reporting different than that of another one of the multiple predefined encoding. As yet another example, one of the multiple predefined encoding may have an accuracy or quantization scheme different than that of another one of the multiple predefined encoding. As yet another example, the ML model used for at least one of the multiple predefined encoding is selectable from a teacher ML model and a configured group of student ML models of the teacher ML model.

At block 806, the terminal device transmits the compressed characteristics of the channel information to a network node. With the method of FIG. 8, since a separate ML model is trained for a different characteristic of the channel information, it is possible to reduce the complexity of compression of channel information.

FIG. 9 is a flowchart illustrating a method performed by a terminal device according to an embodiment of the disclosure. As shown, the method comprises blocks 908-910, and blocks 802-806 as described above. At block 908, the terminal device selects a configured group of predefined encoding from the multiple predefined encoding. The selection may be performed based on hardware capability of the terminal device, or any other suitable factors (e.g. required feedback quality of the channel information, channel bands used between the network node and the terminal device, mobility status of the terminal device, etc.). At block 910, the terminal device transmits information about the selected configured group of predefined encoding to the network node. The information about the selected configured group of predefined encoding may comprise, but not limited to, IDs of the ML models used for the selected configured group of predefined encoding. Blocks 802-806 have been described above and their details are omitted here for brevity. With the method of FIG. 9, due to the selection, the flexibility can be enhanced in the compression of the channel information to suit different application scenarios.

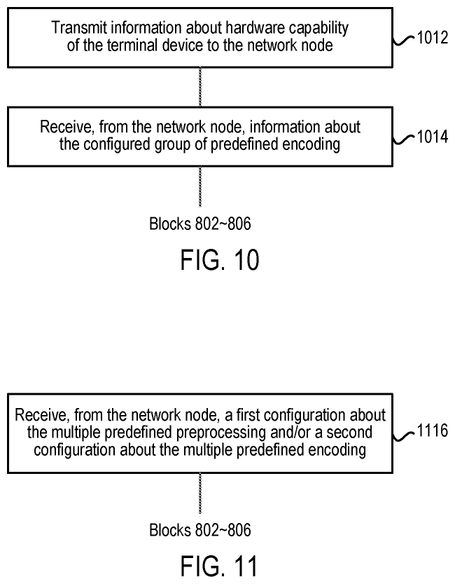

FIG. 10 is a flowchart illustrating a method performed by a terminal device according to an embodiment of the disclosure. As shown, the method comprises blocks 1012-1014, and blocks 802-806 as described above. At block 1012, the terminal device transmits information about hardware capability of the terminal device to the network node. This can facilitate the selection made by the network node. At block 1014, the terminal device receives, from the network node, information about the configured group of predefined encoding. The information about the selected configured group of predefined encoding may comprise, but not limited to, IDs of the ML models used for the selected configured group of predefined encoding. Blocks 802-806 have been described above and their details are omitted here for brevity. With the method of FIG. 10, by facilitating the selection made by the network node, the flexibility can be enhanced in the compression of the channel information to suit different application scenarios.

FIG. 11 is a flowchart illustrating a method performed by a terminal device according to an embodiment of the disclosure. As shown, the method comprises block 1116, and blocks 808-806 as described above. At block 1116, the terminal device receives, from the network node, a first configuration about the multiple predefined preprocessing and/or a second configuration about the multiple predefined encoding. The first configuration may comprise, but not limited to, IDs of codebooks used for the multiple predefined preprocessing. The second configuration may comprise, but not limited to, one or more of: input data types and formats for the multiple predefined encoding; output code types and formats for the multiple predefined encoding; reporting periods of encoded codes from the multiple predefined encoding; life-durations of the multiple predefined encoding; and metric for triggering refining of each of the multiple predefined encoding. The first configuration and/or the second configuration may be received via one or more of RRC signaling and MAC signaling. With the method of FIG. 11, it is possible to support the reduction of complexity of channel information compression.

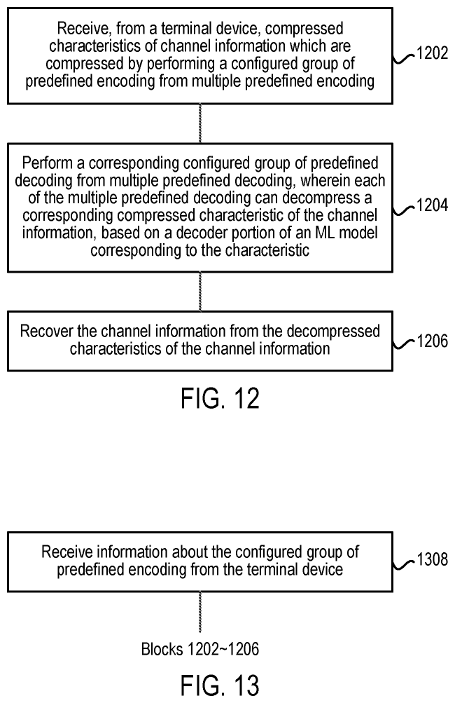

FIG. 12 is a flowchart illustrating a method performed by a network node according to an embodiment of the disclosure. At block 1202, the network node receives, from a terminal device, compressed characteristics of channel information which are compressed by performing a configured group of predefined encoding from multiple predefined encoding. Block 1202 corresponds to block 806 and its details are omitted here. At block 1204, the network node performs a corresponding configured group of predefined decoding from multiple predefined decoding. Each of the multiple predefined decoding can decompress a corresponding compressed characteristic of the channel information, based on a decoder portion of an ML model corresponding to the characteristic.

As an example, one of the multiple predefined decoding may use a decompression technique different than that used by another one of the multiple predefined decoding. As another example, one of the multiple predefined decoding may have a frequency of feedback reception different than that of another one of the multiple predefined decoding. As yet another example, one of the multiple predefined decoding may have an accuracy or quantization scheme different than that of another one of the multiple predefined decoding. As yet another example, the ML model used for at least one of the multiple predefined decoding is selectable from a teacher ML model and a configured group of student ML models of the teacher ML model.

At block 1206, the network node recovers the channel information from the decompressed characteristics of the channel information. For example, the decompressed characteristics of the channel information may be combined to generate the recovered channel information. Such combining process may be inverse to the decomposition processes performed by the configured group of predefined preprocessing at the terminal device. With the method of FIG. 12, since a separate ML model is trained for a different characteristic of the channel information, it is possible to reduce the complexity of decompression of channel information.

FIG. 13 is a flowchart illustrating a method performed by a network node according to an embodiment of the disclosure. As shown, the method comprises block 1308, and blocks 1202-1206 as described above. At block 1308, the network node receives information about the configured group of predefined encoding from the terminal device. The information about the configured group of predefined encoding may comprise, but not limited to, IDs of the ML models used for the configured group of predefined encoding. With the IDs of the ML models, the configured group of predefined decoding corresponding to the configured group of predefined encoding can be determined. Blocks 1202-1206 have been described above and their details are omitted here. With the method of FIG. 13, since the selection made by the terminal device can be supported by the network node, the flexibility can be enhanced in the compression of the channel information to suit different application scenarios.

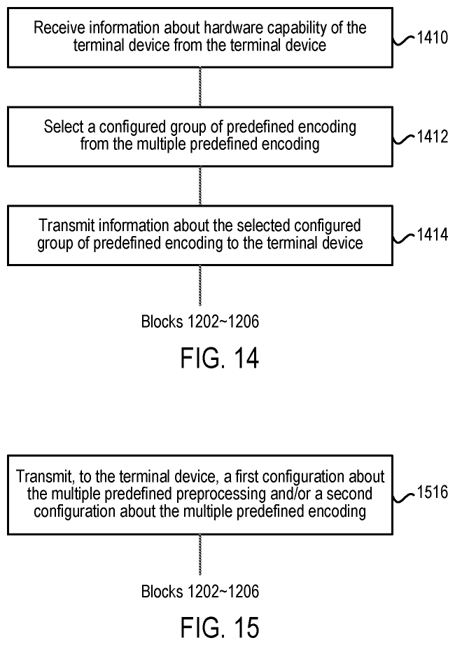

FIG. 14 is a flowchart illustrating a method performed by a network node according to an embodiment of the disclosure. As shown, the method comprises blocks 1410-1414, and blocks 1202-1206 as described above. At block 1410, the network node receives information about hardware capability of the terminal device from the terminal device. This can facilitate the selection made by the network node as described later. At block 1412, the network node selects a configured group of predefined encoding from the multiple predefined encoding. The selection may be performed based on one or more of: hardware capability of the terminal device; hardware capability of the network node; requirements of transmission scheme of the network node; required feedback quality of the channel information; link status between the network node and the terminal device; channel bands used between the network node and the terminal device; mobility status of the terminal device; etc. At block 1414, the network node transmits information about the selected configured group of predefined encoding to the terminal device. The information about the selected configured group of predefined encoding may comprise, but not limited to, IDs of the ML models used for the selected configured group of predefined encoding. Blocks 1202-1206 have been described above and their details are omitted here. With the method of FIG. 14, due to the selection, the flexibility can be enhanced in the compression of the channel information to suit different application scenarios.

FIG. 15 is a flowchart illustrating a method performed by a network node according to an embodiment of the disclosure. As shown, the method comprises block 1516, and blocks 1202-1206 as described above. At block 1516, the network node transmits, to the terminal device, a first configuration about the multiple predefined preprocessing and/or a second configuration about the multiple predefined encoding. The first configuration may comprise, but not limited to, IDs of codebooks used for the multiple predefined preprocessing. The second configuration may comprise, but not limited to, one or more of: input data types and formats for the multiple predefined encoding; output code types and formats for the multiple predefined encoding; reporting periods of encoded codes from the multiple predefined encoding; life-durations of the multiple predefined encoding; and metric for triggering refining of each of the multiple predefined encoding. The first configuration and/or the second configuration may be transmitted via one or more of RRC signaling and MAC signaling. With the method of FIG. 15, it is possible to support the reduction of complexity of channel information compression.

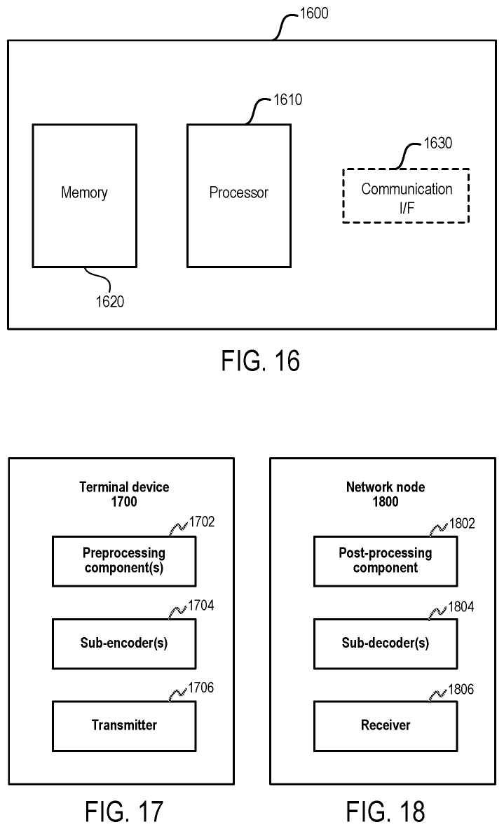

FIG. 16 is a block diagram showing an apparatus suitable for use in practicing some embodiments of the disclosure. For example, any one of the terminal device and the network node described above may be implemented through the apparatus 1600. As shown, the apparatus 1600 may include a processor 1610, a memory 1620 that stores a program, and optionally a communication interface 1630 for communicating data with other external devices through wired and/or wireless communication.

The program includes program instructions that, when executed by the processor 1610, enable the apparatus 1600 to operate in accordance with the embodiments of the present disclosure, as discussed above. That is, the embodiments of the present disclosure may be implemented at least in part by computer software executable by the processor 1610, or by hardware, or by a combination of software and hardware.

The memory 1620 may be of any type suitable to the local technical environment and may be implemented using any suitable data storage technology, such as semiconductor based memory devices, flash memories, magnetic memory devices and systems, optical memory devices and systems, fixed memories and removable memories. The processor 1610 may be of any type suitable to the local technical environment, and may include one or more of general purpose computers, special purpose computers, microprocessors, digital signal processors (DSPs) and processors based on multi-core processor architectures, as non-limiting examples.

FIG. 17 is a block diagram showing a terminal device according to an embodiment of the disclosure. As shown, the terminal device 1700 comprises a configured group of preprocessing components 1702, a configured group of sub-encoders 1704, and a transmitter 1706. The configured group of preprocessing components 1702 may be configured to perform a configured group of predefined preprocessing from multiple predefined preprocessing, as described above with respect to block 802. Each of the multiple predefined preprocessing can determine, from channel information estimated by the terminal device, a different characteristic of the channel information. The configured group of sub-encoders 1704 may be configured to perform a corresponding configured group of predefined encoding from multiple predefined encoding, as described above with respect to block 804. Each of the multiple predefined encoding can compress the different characteristic of the channel information, based on an encoder portion of an ML model corresponding to the different characteristic. The transmitter 1706 may be configured to transmit the compressed characteristics of the channel information to a network node, as described above with respect to block 806.

FIG. 18 is a block diagram showing a network node according to an embodiment of the disclosure. As shown, the network node 1800 comprises a receiver 1806, a configured group of sub-decoders 1804 and a post-processing component 1802. The receiver 1806 may be configured to receive, from a terminal device, compressed characteristics of channel information which are compressed by performing a configured group of predefined encoding from multiple predefined encoding, as described above with respect to block 1202. The configured group of sub-decoders 1804 may be configured to perform a corresponding configured group of predefined decoding from multiple predefined decoding, as described above with respect to block 1204. Each of the multiple predefined decoding can decompress a corresponding compressed characteristic of the channel information, based on a decoder portion of an ML model corresponding to the characteristic. The post-processing component 1802 may be configured to recover the channel information from the decompressed characteristics of the channel information, as described above with respect to block 1206. The components described above may be implemented by hardware, or software, or a combination of both.

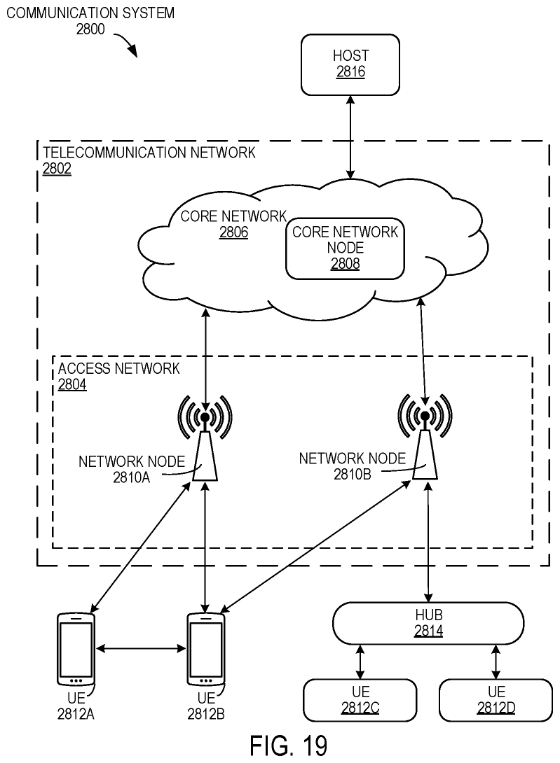

FIG. 19 shows an example of a communication system 2800 in accordance with some embodiments.

In the example, the communication system 2800 includes a telecommunication network 2802 that includes an access network 2804, such as a radio access network (RAN), and a core network 2806, which includes one or more core network nodes 2808. The access network 2804 includes one or more access network nodes, such as network nodes 2810a and 2810b (one or more of which may be generally referred to as network nodes 2810), or any other similar 3rd Generation Partnership Project (3GPP) access node or non-3GPP access point. The network nodes 2810 facilitate direct or indirect connection of user equipment (UE), such as by connecting UEs 2812a, 2812b, 2812c, and 2812d (one or more of which may be generally referred to as UEs 2812) to the core network 2806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2800 may include any number of wired or wireless networks, network nodes, UEs, and/or any other components or systems that may facilitate or participate in the communication of data and/or signals whether via wired or wireless connections. The communication system 2800 may include and/or interface with any type of communication, telecommunication, data, cellular, radio network, and/or other similar type of system.

The UEs 2812 may be any of a wide variety of communication devices, including wireless devices arranged, configured, and/or operable to communicate wirelessly with the network nodes 2810 and other communication devices. Similarly, the network nodes 2810 are arranged, capable, configured, and/or operable to communicate directly or indirectly with the UEs 2812 and/or with other network nodes or equipment in the telecommunication network 2802 to enable and/or provide network access, such as wireless network access, and/or to perform other functions, such as administration in the telecommunication network 2802.

In the depicted example, the core network 2806 connects the network nodes 2810 to one or more hosts, such as host 2816. These connections may be direct or indirect via one or more intermediary networks or devices. In other examples, network nodes may be directly coupled to hosts. The core network 2806 includes one more core network nodes (e.g., core network node 2808) that are structured with hardware and software components. Features of these components may be substantially similar to those described with respect to the UEs, network nodes, and/or hosts, such that the descriptions thereof are generally applicable to the corresponding components of the core network node 2808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2816 may be under the ownership or control of a service provider other than an operator or provider of the access network 2804 and/or the telecommunication network 2802, and may be operated by the service provider or on behalf of the service provider. The host 2816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2800 of FIG. 19 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2802 is a cellular network that implements 3GPP standardized features. Accordingly, the telecommunications network 2802 may support network slicing to provide different logical networks to different devices that are connected to the telecommunication network 2802. For example, the telecommunications network 2802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2812 are configured to transmit and/or receive information without direct human interaction. For instance, a UE may be designed to transmit information to the access network 2804 on a predetermined schedule, when triggered by an internal or external event, or in response to requests from the access network 2804. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2814 communicates with the access network 2804 to facilitate indirect communication between one or more UEs (e.g., UE 2812c and/or 2812d) and network nodes (e.g., network node 2810b). In some examples, the hub 2814 may be a controller, router, content source and analytics, or any of the other communication devices described herein regarding UEs. For example, the hub 2814 may be a broadband router enabling access to the core network 2806 for the UEs. As another example, the hub 2814 may be a controller that sends commands or instructions to one or more actuators in the UEs. Commands or instructions may be received from the UEs, network nodes 2810, or by executable code, script, process, or other instructions in the hub 2814. As another example, the hub 2814 may be a data collector that acts as temporary storage for UE data and, in some embodiments, may perform analysis or other processing of the data. As another example, the hub 2814 may be a content source. For example, for a UE that is a VR headset, display, loudspeaker or other media delivery device, the hub 2814 may retrieve VR assets, video, audio, or other media or data related to sensory information via a network node, which the hub 2814 then provides to the UE either directly, after performing local processing, and/or after adding additional local content. In still another example, the hub 2814 acts as a proxy server or orchestrator for the UEs, in particular in if one or more of the UEs are low energy IoT devices.

The hub 2814 may have a constant/persistent or intermittent connection to the network node 2810b. The hub 2814 may also allow for a different communication scheme and/or schedule between the hub 2814 and UEs (e.g., UE 2812c and/or 2812d), and between the hub 2814 and the core network 2806. In other examples, the hub 2814 is connected to the core network 2806 and/or one or more UEs via a wired connection. Moreover, the hub 2814 may be configured to connect to an M2M service provider over the access network 2804 and/or to another UE over a direct connection. In some scenarios, UEs may establish a wireless connection with the network nodes 2810 while still connected via the hub 2814 via a wired or wireless connection. In some embodiments, the hub 2814 may be a dedicated hub-that is, a hub whose primary function is to route communications to/from the UEs from/to the network node 2810b. In other embodiments, the hub 2814 may be a non-dedicated hub-that is, a device which is capable of operating to route communications between the UEs and network node 2810b, but which is additionally capable of operating as a communication start and/or end point for certain data channels.

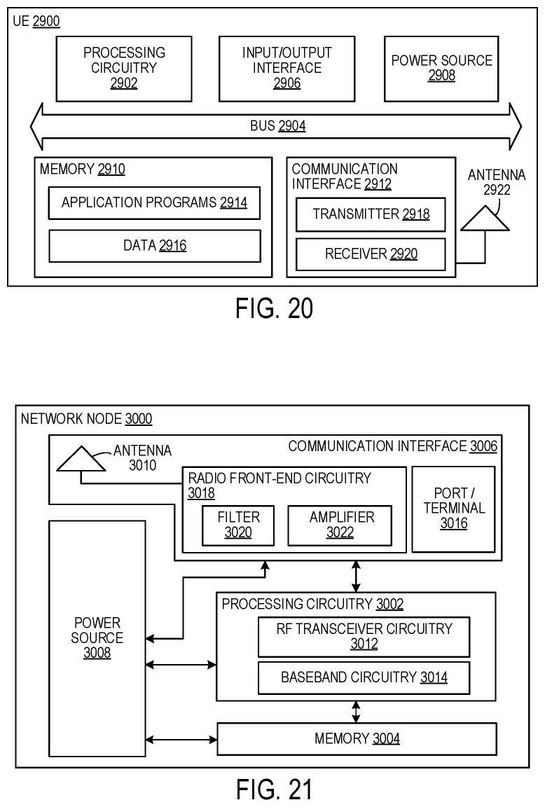

FIG. 20 shows a UE 2900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2900 includes processing circuitry 2902 that is operatively coupled via a bus 2904 to an input/output interface 2906, a power source 2908, a memory 2910, a communication interface 2912, and/or any other component, or any combination thereof. Certain UEs may utilize all or a subset of the components shown in FIG. 20. The level of integration between the components may vary from one UE to another UE. Further, certain UEs may contain multiple instances of a component, such as multiple processors, memories, transceivers, transmitters, receivers, etc.

The processing circuitry 2902 is configured to process instructions and data and may be configured to implement any sequential state machine operative to execute instructions stored as machine-readable computer programs in the memory 2910. The processing circuitry 2902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2902 may include multiple central processing units (CPUs).

In the example, the input/output interface 2906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2908 is structured as a battery or battery pack. Other types of power sources, such as an external power source (e.g., an electricity outlet), photovoltaic device, or power cell, may be used. The power source 2908 may further include power circuitry for delivering power from the power source 2908 itself, and/or an external power source, to the various parts of the UE 2900 via input circuitry or an interface such as an electrical power cable. Delivering power may be, for example, for charging of the power source 2908. Power circuitry may perform any formatting, converting, or other modification to the power from the power source 2908 to make the power suitable for the respective components of the UE 2900 to which power is supplied.

The memory 2910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2910 includes one or more application programs 2914, such as an operating system, web browser application, a widget, gadget engine, or other application, and corresponding data 2916. The memory 2910 may store, for use by the UE 2900, any of a variety of various operating systems or combinations of operating systems.

The memory 2910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2910 may allow the UE 2900 to access instructions, application programs and the like, stored on transitory or non-transitory memory media, to off-load data, or to upload data. An article of manufacture, such as one utilizing a communication system may be tangibly embodied as or in the memory 2910, which may be or comprise a device-readable storage medium.

The processing circuitry 2902 may be configured to communicate with an access network or other network using the communication interface 2912. The communication interface 2912 may comprise one or more communication subsystems and may include or be communicatively coupled to an antenna 2922. The communication interface 2912 may include one or more transceivers used to communicate, such as by communicating with one or more remote transceivers of another device capable of wireless communication (e.g., another UE or a network node in an access network). Each transceiver may include a transmitter 2918 and/or a receiver 2920 appropriate to provide network communications (e.g., optical, electrical, frequency allocations, and so forth). Moreover, the transmitter 2918 and receiver 2920 may be coupled to one or more antennas (e.g., antenna 2922) and may share circuit components, software or firmware, or alternatively be implemented separately.

In the illustrated embodiment, communication functions of the communication interface 2912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2900 shown in FIG. 20.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 21 shows a network node 3000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3000 includes a processing circuitry 3002, a memory 3004, a communication interface 3006, and a power source 3008. The network node 3000 may be composed of multiple physically separate components (e.g., a NodeB component and a RNC component, or a BTS component and a BSC component, etc.), which may each have their own respective components. In certain scenarios in which the network node 3000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 3000 may be configured to support multiple radio access technologies (RATs). In such embodiments, some components may be duplicated (e.g., separate memory 3004 for different RATs) and some components may be reused (e.g., a same antenna 3010 may be shared by different RATs). The network node 3000 may also include multiple sets of the various illustrated components for different wireless technologies integrated into network node 3000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 3000.

The processing circuitry 3002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3000 components, such as the memory 3004, to provide network node 3000 functionality.

In some embodiments, the processing circuitry 3002 includes a system on a chip (SOC). In some embodiments, the processing circuitry 3002 includes one or more of radio frequency (RF) transceiver circuitry 3012 and baseband processing circuitry 3014. In some embodiments, the radio frequency (RF) transceiver circuitry 3012 and the baseband processing circuitry 3014 may be on separate chips (or sets of chips), boards, or units, such as radio units and digital units. In alternative embodiments, part or all of RF transceiver circuitry 3012 and baseband processing circuitry 3014 may be on the same chip or set of chips, boards, or units.

The memory 3004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3002. The memory 3004 may store any suitable instructions, data, or information, including a computer program, software, an application including one or more of logic, rules, code, tables, and/or other instructions capable of being executed by the processing circuitry 3002 and utilized by the network node 3000. The memory 3004 may be used to store any calculations made by the processing circuitry 3002 and/or any data received via the communication interface 3006. In some embodiments, the processing circuitry 3002 and memory 3004 is integrated.

The communication interface 3006 is used in wired or wireless communication of signaling and/or data between a network node, access network, and/or UE. As illustrated, the communication interface 3006 comprises port(s)/terminal(s) 3016 to send and receive data, for example to and from a network over a wired connection. The communication interface 3006 also includes radio front-end circuitry 3018 that may be coupled to, or in certain embodiments a part of, the antenna 3010. Radio front-end circuitry 3018 comprises filters 3020 and amplifiers 3022. The radio front-end circuitry 3018 may be connected to an antenna 3010 and processing circuitry 3002. The radio front-end circuitry may be configured to condition signals communicated between antenna 3010 and processing circuitry 3002. The radio front-end circuitry 3018 may receive digital data that is to be sent out to other network nodes or UEs via a wireless connection. The radio front-end circuitry 3018 may convert the digital data into a radio signal having the appropriate channel and bandwidth parameters using a combination of filters 3020 and/or amplifiers 3022. The radio signal may then be transmitted via the antenna 3010. Similarly, when receiving data, the antenna 3010 may collect radio signals which are then converted into digital data by the radio front-end circuitry 3018. The digital data may be passed to the processing circuitry 3002. In other embodiments, the communication interface may comprise different components and/or different combinations of components.

In certain alternative embodiments, the network node 3000 does not include separate radio front-end circuitry 3018, instead, the processing circuitry 3002 includes radio front-end circuitry and is connected to the antenna 3010. Similarly, in some embodiments, all or some of the RF transceiver circuitry 3012 is part of the communication interface 3006. In still other embodiments, the communication interface 3006 includes one or more ports or terminals 3016, the radio front-end circuitry 3018, and the RF transceiver circuitry 3012, as part of a radio unit (not shown), and the communication interface 3006 communicates with the baseband processing circuitry 3014, which is part of a digital unit (not shown).

The antenna 3010 may include one or more antennas, or antenna arrays, configured to send and/or receive wireless signals. The antenna 3010 may be coupled to the radio front-end circuitry 3018 and may be any type of antenna capable of transmitting and receiving data and/or signals wirelessly. In certain embodiments, the antenna 3010 is separate from the network node 3000 and connectable to the network node 3000 through an interface or port.

The antenna 3010, communication interface 3006, and/or the processing circuitry 3002 may be configured to perform any receiving operations and/or certain obtaining operations described herein as being performed by the network node. Any information, data and/or signals may be received from a UE, another network node and/or any other network equipment. Similarly, the antenna 3010, the communication interface 3006, and/or the processing circuitry 3002 may be configured to perform any transmitting operations described herein as being performed by the network node. Any information, data and/or signals may be transmitted to a UE, another network node and/or any other network equipment.

The power source 3008 provides power to the various components of network node 3000 in a form suitable for the respective components (e.g., at a voltage and current level needed for each respective component). The power source 3008 may further comprise, or be coupled to, power management circuitry to supply the components of the network node 3000 with power for performing the functionality described herein. For example, the network node 3000 may be connectable to an external power source (e.g., the power grid, an electricity outlet) via an input circuitry or interface such as an electrical cable, whereby the external power source supplies power to power circuitry of the power source 3008. As a further example, the power source 3008 may comprise a source of power in the form of a battery or battery pack which is connected to, or integrated in, power circuitry. The battery may provide backup power should the external power source fail.

Embodiments of the network node 3000 may include additional components beyond those shown in FIG. 21 for providing certain aspects of the network node's functionality, including any of the functionality described herein and/or any functionality necessary to support the subject matter described herein. For example, the network node 3000 may include user interface equipment to allow input of information into the network node 3000 and to allow output of information from the network node 3000. This may allow a user to perform diagnostic, maintenance, repair, and other administrative functions for the network node 3000.

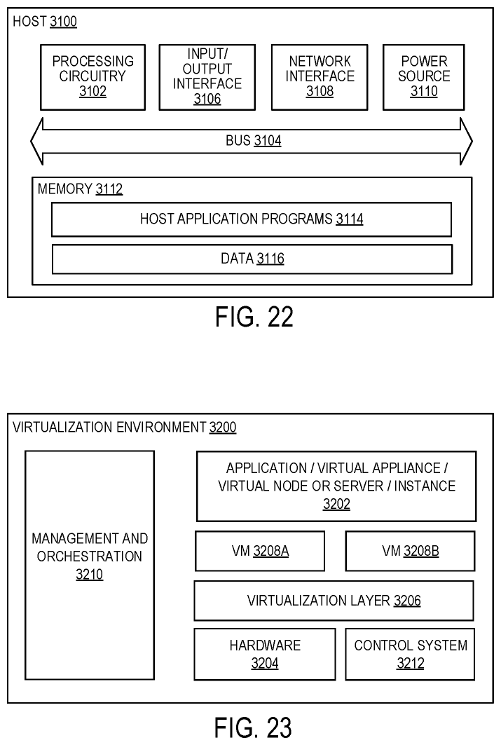

FIG. 22 is a block diagram of a host 3100, which may be an embodiment of the host 2816 of FIG. 19, in accordance with various aspects described herein. As used herein, the host 3100 may be or comprise various combinations hardware and/or software, including a standalone server, a blade server, a cloud-implemented server, a distributed server, a virtual machine, container, or processing resources in a server farm. The host 3100 may provide one or more services to one or more UEs.

The host 3100 includes processing circuitry 3102 that is operatively coupled via a bus 3104 to an input/output interface 3106, a network interface 3108, a power source 3110, and a memory 3112. Other components may be included in other embodiments. Features of these components may be substantially similar to those described with respect to the devices of previous figures, such as FIGS. 20 and 21, such that the descriptions thereof are generally applicable to the corresponding components of host 3100.

The memory 3112 may include one or more computer programs including one or more host application programs 3114 and data 3116, which may include user data, e.g., data generated by a UE for the host 3100 or data generated by the host 3100 for a UE. Embodiments of the host 3100 may utilize only a subset or all of the components shown. The host application programs 3114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3114 may also provide for user authentication and licensing checks and may periodically report health, routes, and content availability to a central node, such as a device in or on the edge of a core network. Accordingly, the host 3100 may select and/or indicate a different host for over-the-top services for a UE. The host application programs 3114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 23 is a block diagram illustrating a virtualization environment 3200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3202 (which may alternatively be called software instances, virtual appliances, network functions, virtual nodes, virtual network functions, etc.) are run in the virtualization environment 3200 to implement some of the features, functions, and/or benefits of some of the embodiments disclosed herein.

Hardware 3204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3206 (also referred to as hypervisors or virtual machine monitors (VMMs)), provide VMs 3208a and 3208b (one or more of which may be generally referred to as VMs 3208), and/or perform any of the functions, features and/or benefits described in relation with some embodiments described herein. The virtualization layer 3206 may present a virtual operating platform that appears like networking hardware to the VMs 3208.

The VMs 3208 comprise virtual processing, virtual memory, virtual networking or interface and virtual storage, and may be run by a corresponding virtualization layer 3206. Different embodiments of the instance of a virtual appliance 3202 may be implemented on one or more of VMs 3208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3208 may be a software implementation of a physical machine that runs programs as if they were executing on a physical, non-virtualized machine. Each of the VMs 3208, and that part of hardware 3204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3208 on top of the hardware 3204 and corresponds to the application 3202.

Hardware 3204 may be implemented in a standalone network node with generic or specific components. Hardware 3204 may implement some functions via virtualization. Alternatively, hardware 3204 may be part of a larger cluster of hardware (e.g. such as in a data center or CPE) where many hardware nodes work together and are managed via management and orchestration 3210, which, among others, oversees lifecycle management of applications 3202. In some embodiments, hardware 3204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3212 which may alternatively be used for communication between hardware nodes and radio units.

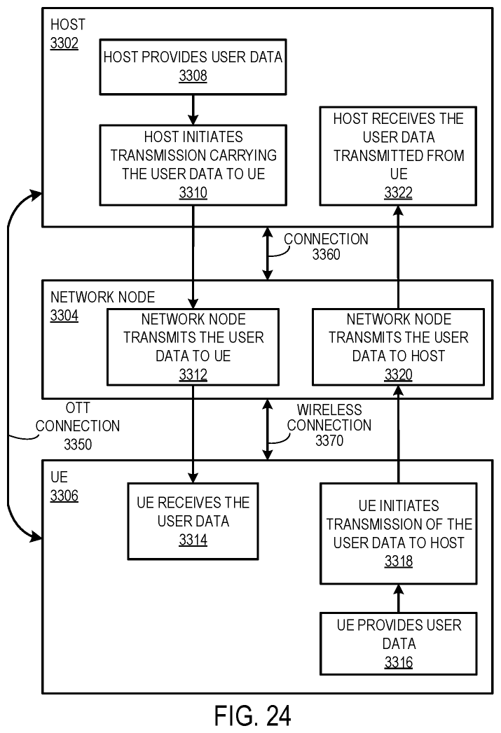

FIG. 24 shows a communication diagram of a host 3302 communicating via a network node 3304 with a UE 3306 over a partially wireless connection in accordance with some embodiments. Example implementations, in accordance with various embodiments, of the UE (such as a UE 2812a of FIG. 19 and/or UE 2900 of FIG. 20), network node (such as network node 2810a of FIG. 19 and/or network node 3000 of FIG. 21), and host (such as host 2816 of FIG. 19 and/or host 3100 of FIG. 22) discussed in the preceding paragraphs will now be described with reference to FIG. 24.

Like host 3100, embodiments of host 3302 include hardware, such as a communication interface, processing circuitry, and memory. The host 3302 also includes software, which is stored in or accessible by the host 3302 and executable by the processing circuitry. The software includes a host application that may be operable to provide a service to a remote user, such as the UE 3306 connecting via an over-the-top (OTT) connection 3350 extending between the UE 3306 and host 3302. In providing the service to the remote user, a host application may provide user data which is transmitted using the OTT connection 3350.

The network node 3304 includes hardware enabling it to communicate with the host 3302 and UE 3306. The connection 3360 may be direct or pass through a core network (like core network 2806 of FIG. 19) and/or one or more other intermediate networks, such as one or more public, private, or hosted networks. For example, an intermediate network may be a backbone network or the Internet.

The UE 3306 includes hardware and software, which is stored in or accessible by UE 3306 and executable by the UE's processing circuitry. The software includes a client application, such as a web browser or operator-specific “app” that may be operable to provide a service to a human or non-human user via UE 3306 with the support of the host 3302. In the host 3302, an executing host application may communicate with the executing client application via the OTT connection 3350 terminating at the UE 3306 and host 3302. In providing the service to the user, the UE's client application may receive request data from the host's host application and provide user data in response to the request data. The OTT connection 3350 may transfer both the request data and the user data. The UE's client application may interact with the user to generate the user data that it provides to the host application through the OTT connection 3350.

The OTT connection 3350 may extend via a connection 3360 between the host 3302 and the network node 3304 and via a wireless connection 3370 between the network node 3304 and the UE 3306 to provide the connection between the host 3302 and the UE 3306. The connection 3360 and wireless connection 3370, over which the OTT connection 3350 may be provided, have been drawn abstractly to illustrate the communication between the host 3302 and the UE 3306 via the network node 3304, without explicit reference to any intermediary devices and the precise routing of messages via these devices.

As an example of transmitting data via the OTT connection 3350, in step 3308, the host 3302 provides user data, which may be performed by executing a host application. In some embodiments, the user data is associated with a particular human user interacting with the UE 3306. In other embodiments, the user data is associated with a UE 3306 that shares data with the host 3302 without explicit human interaction. In step 3310, the host 3302 initiates a transmission carrying the user data towards the UE 3306. The host 3302 may initiate the transmission responsive to a request transmitted by the UE 3306. The request may be caused by human interaction with the UE 3306 or by operation of the client application executing on the UE 3306. The transmission may pass via the network node 3304, in accordance with the teachings of the embodiments described throughout this disclosure. Accordingly, in step 3312, the network node 3304 transmits to the UE 3306 the user data that was carried in the transmission that the host 3302 initiated, in accordance with the teachings of the embodiments described throughout this disclosure. In step 3314, the UE 3306 receives the user data carried in the transmission, which may be performed by a client application executed on the UE 3306 associated with the host application executed by the host 3302.

In some examples, the UE 3306 executes a client application which provides user data to the host 3302. The user data may be provided in reaction or response to the data received from the host 3302. Accordingly, in step 3316, the UE 3306 may provide user data, which may be performed by executing the client application. In providing the user data, the client application may further consider user input received from the user via an input/output interface of the UE 3306. Regardless of the specific manner in which the user data was provided, the UE 3306 initiates, in step 3318, transmission of the user data towards the host 3302 via the network node 3304. In step 3320, in accordance with the teachings of the embodiments described throughout this disclosure, the network node 3304 receives user data from the UE 3306 and initiates transmission of the received user data towards the host 3302. In step 3322, the host 3302 receives the user data carried in the transmission initiated by the UE 3306.

One or more of the various embodiments improve the performance of OTT services provided to the UE 3306 using the OTT connection 3350, in which the wireless connection 3370 forms the last segment. More precisely, the teachings of these embodiments may improve the power consumption and thereby provide benefits such as extended battery lifetime.

In an example scenario, factory status information may be collected and analyzed by the host 3302. As another example, the host 3302 may process audio and video data which may have been retrieved from a UE for use in creating maps. As another example, the host 3302 may collect and analyze real-time data to assist in controlling vehicle congestion (e.g., controlling traffic lights). As another example, the host 3302 may store surveillance video uploaded by a UE. As another example, the host 3302 may store or control access to media content such as video, audio, VR or AR which it can broadcast, multicast or unicast to UEs. As other examples, the host 3302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3350 between the host 3302 and UE 3306, in response to variations in the measurement results. The measurement procedure and/or the network functionality for reconfiguring the OTT connection may be implemented in software and hardware of the host 3302 and/or UE 3306. In some embodiments, sensors (not shown) may be deployed in or in association with other devices through which the OTT connection 3350 passes; the sensors may participate in the measurement procedure by supplying values of the monitored quantities exemplified above, or supplying values of other physical quantities from which software may compute or estimate the monitored quantities. The reconfiguring of the OTT connection 3350 may include message format, retransmission settings, preferred routing etc. ; the reconfiguring need not directly alter the operation of the network node 3304. Such procedures and functionalities may be known and practiced in the art. In certain embodiments, measurements may involve proprietary UE signaling that facilitates measurements of throughput, propagation times, latency and the like, by the host 3302. The measurements may be implemented in that software causes messages to be transmitted, in particular empty or ‘dummy’ messages, using the OTT connection 3350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

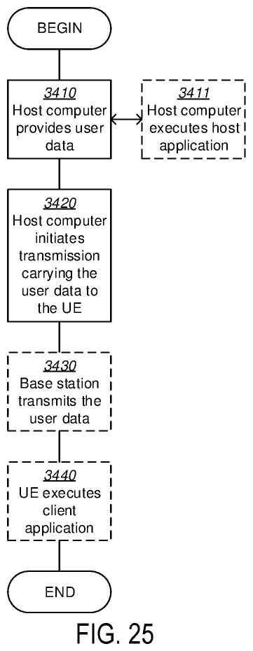

FIG. 25 is a flowchart illustrating a method implemented in a communication system, in accordance with one embodiment. The communication system includes a host computer, a base station and a UE which may be those described with reference to FIGS. 19 and 24. For simplicity of the present disclosure, only drawing references to FIG. 25 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

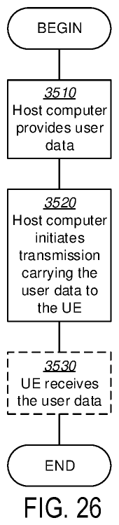

FIG. 26 is a flowchart illustrating a method implemented in a communication system, in accordance with one embodiment. The communication system includes a host computer, a base station and a UE which may be those described with reference to FIGS. 19 and 24. For simplicity of the present disclosure, only drawing references to FIG. 26 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

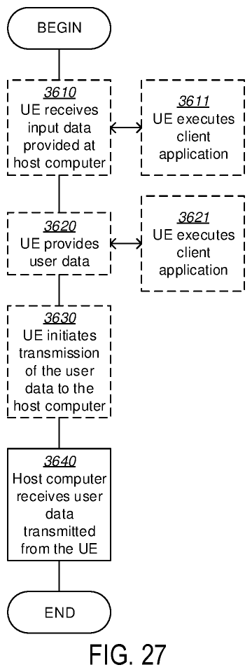

FIG. 27 is a flowchart illustrating a method implemented in a communication system, in accordance with one embodiment. The communication system includes a host computer, a base station and a UE which may be those described with reference to FIGS. 19 and 24. For simplicity of the present disclosure, only drawing references to FIG. 27 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

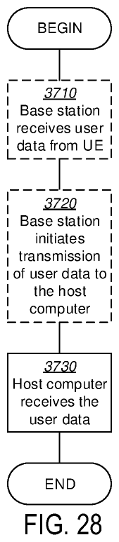

FIG. 28 is a flowchart illustrating a method implemented in a communication system, in accordance with one embodiment. The communication system includes a host computer, a base station and a UE which may be those described with reference to FIGS. 19 and 24. For simplicity of the present disclosure, only drawing references to FIG. 28 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

In an aspect of the disclosure, there is provided a method implemented in a communication system including a host computer, a base station and a terminal device. The method may comprise, at the host computer, providing user data. The method may further comprise, at the host computer, initiating a transmission carrying the user data to the terminal device via a cellular network comprising the base station. The base station may receive, from a terminal device, compressed characteristics of channel information which are compressed by performing a configured group of predefined encoding from multiple predefined encoding. The base station may perform a corresponding configured group of predefined decoding from multiple predefined decoding. Each of the multiple predefined decoding can decompress a corresponding compressed characteristic of the channel information, based on a decoder portion of an ML model corresponding to the characteristic. The base station may recover the channel information from the decompressed characteristics of the channel information.

In an embodiment of the disclosure, the method may further comprise, at the base station, transmitting the user data.

In an embodiment of the disclosure, the user data may be provided at the host computer by executing a host application. The method may further comprise, at the terminal device, executing a client application associated with the host application.

In another aspect of the disclosure, there is provided a communication system including a host computer comprising processing circuitry configured to provide user data and a communication interface configured to forward the user data to a cellular network for transmission to a terminal device. The cellular network may comprise a base station having a radio interface and processing circuitry. The base station's processing circuitry may be configured to receive, from a terminal device, compressed characteristics of channel information which are compressed by performing a configured group of predefined encoding from multiple predefined encoding. The base station's processing circuitry may be further configured to perform a corresponding configured group of predefined decoding from multiple predefined decoding. Each of the multiple predefined decoding can decompress a corresponding compressed characteristic of the channel information, based on a decoder portion of an ML model corresponding to the characteristic. The base station's processing circuitry may be further configured to recover the channel information from the decompressed characteristics of the channel information.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application, thereby providing the user data. The terminal device may comprise processing circuitry configured to execute a client application associated with the host application.

In yet another aspect of the disclosure, there is provided a method implemented in a communication system including a host computer, a base station and a terminal device. The method may comprise, at the host computer, providing user data. The method may further comprise, at the host computer, initiating a transmission carrying the user data to the terminal device via a cellular network comprising the base station. The terminal device may perform a configured group of predefined preprocessing from multiple predefined preprocessing. Each of the multiple predefined preprocessing can determine, from channel information estimated by the terminal device, a different characteristic of the channel information. The terminal device may perform a corresponding configured group of predefined encoding from multiple predefined encoding. Each of the multiple predefined encoding can compress the different characteristic of the channel information, based on an encoder portion of an ML model corresponding to the different characteristic. The terminal device may transmit the compressed characteristics of the channel information to the base station.

In an embodiment of the disclosure, the method may further comprise, at the terminal device, receiving the user data from the base station.

In yet another aspect of the disclosure, there is provided a communication system including a host computer comprising processing circuitry configured to provide user data and a communication interface configured to forward user data to a cellular network for transmission to a terminal device. The terminal device may comprise a radio interface and processing circuitry. The processing circuitry of the terminal device may be configured to perform a configured group of predefined preprocessing from multiple predefined preprocessing. Each of the multiple predefined preprocessing can determine, from channel information estimated by the terminal device, a different characteristic of the channel information. The processing circuitry of the terminal device may be further configured to perform a corresponding configured group of predefined encoding from multiple predefined encoding. Each of the multiple predefined encoding can compress the different characteristic of the channel information, based on an encoder portion of an ML model corresponding to the different characteristic. The processing circuitry of the terminal device may be further configured to transmit the compressed characteristics of the channel information to a base station.

In an embodiment of the disclosure, the communication system may further include the terminal device.

In an embodiment of the disclosure, the cellular network may further include a base station configured to communicate with the terminal device.

In an embodiment of the disclosure, the processing circuitry of the host computer may be configured to execute a host application, thereby providing the user data. The processing circuitry of the terminal device may be configured to execute a client application associated with the host application.

In yet another aspect of the disclosure, there is provided a method implemented in a communication system including a host computer, a base station and a terminal device. The method may comprise, at the host computer, receiving user data transmitted to the base station from the terminal device. The terminal device may perform a configured group of predefined preprocessing from multiple predefined preprocessing. Each of the multiple predefined preprocessing can determine, from channel information estimated by the terminal device, a different characteristic of the channel information. The terminal device may perform a corresponding configured group of predefined encoding from multiple predefined encoding. Each of the multiple predefined encoding can compress the different characteristic of the channel information, based on an encoder portion of an ML model corresponding to the different characteristic. The terminal device may transmit the compressed characteristics of the channel information to the base station.

In an embodiment of the disclosure, the method may further comprise, at the terminal device, providing the user data to the base station.

In an embodiment of the disclosure, the method may further comprise, at the terminal device, executing a client application, thereby providing the user data to be transmitted. The method may further comprise, at the host computer, executing a host application associated with the client application.

In an embodiment of the disclosure, the method may further comprise, at the terminal device, executing a client application. The method may further comprise, at the terminal device, receiving input data to the client application. The input data may be provided at the host computer by executing a host application associated with the client application. The user data to be transmitted may be provided by the client application in response to the input data.

In yet another aspect of the disclosure, there is provided a communication system including a host computer comprising a communication interface configured to receive user data originating from a transmission from a terminal device to a base station. The terminal device may comprise a radio interface and processing circuitry. The processing circuitry of the terminal device may be configured to perform a configured group of predefined preprocessing from multiple predefined preprocessing. Each of the multiple predefined preprocessing can determine, from channel information estimated by the terminal device, a different characteristic of the channel information. The processing circuitry of the terminal device may be further configured to perform a corresponding configured group of predefined encoding from multiple predefined encoding. Each of the multiple predefined encoding can compress the different characteristic of the channel information, based on an encoder portion of an ML model corresponding to the different characteristic. The processing circuitry of the terminal device may be further configured to transmit the compressed characteristics of the channel information to the base station.

In an embodiment of the disclosure, the communication system may further include the terminal device.

In an embodiment of the disclosure, the communication system may further include the base station. The base station may comprise a radio interface configured to communicate with the terminal device and a communication interface configured to forward to the host computer the user data carried by a transmission from the terminal device to the base station.

In an embodiment of the disclosure, the processing circuitry of the host computer may be configured to execute a host application. The processing circuitry of the terminal device may be configured to execute a client application associated with the host application, thereby providing the user data.

In an embodiment of the disclosure, the processing circuitry of the host computer may be configured to execute a host application, thereby providing request data. The processing circuitry of the terminal device may be configured to execute a client application associated with the host application, thereby providing the user data in response to the request data.

In yet another aspect of the disclosure, there is provided a method implemented in a communication system including a host computer, a base station and a terminal device. The method may comprise, at the host computer, receiving, from the base station, user data originating from a transmission which the base station has received from the terminal device. The base station may receive, from a terminal device, compressed characteristics of channel information which are compressed by performing a configured group of predefined encoding from multiple predefined encoding. The base station may perform a corresponding configured group of predefined decoding from multiple predefined decoding. Each of the multiple predefined decoding can decompress a corresponding compressed characteristic of the channel information, based on a decoder portion of an ML model corresponding to the characteristic. The base station may recover the channel information from the decompressed characteristics of the channel information.

In an embodiment of the disclosure, the method may further comprise, at the base station, receiving the user data from the terminal device.

In an embodiment of the disclosure, the method may further comprise, at the base station, initiating a transmission of the received user data to the host computer.

In yet another aspect of the disclosure, there is provided a communication system including a host computer comprising a communication interface configured to receive user data originating from a transmission from a terminal device to a base station. The base station may comprise a radio interface and processing circuitry. The base station's processing circuitry may be configured to receive, from a terminal device, compressed characteristics of channel information which are compressed by performing a configured group of predefined encoding from multiple predefined encoding. The base station's processing circuitry may be further configured to perform a corresponding configured group of predefined decoding from multiple predefined decoding. Each of the multiple predefined decoding can decompress a corresponding compressed characteristic of the channel information, based on a decoder portion of an ML model corresponding to the characteristic. The base station's processing circuitry may be further configured to recover the channel information from the decompressed characteristics of the channel information.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application. The terminal device may be configured to execute a client application associated with the host application, thereby providing the user data to be received by the host computer.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A communication system comprising:
a terminal device comprising:
a configured group of preprocessing components configured to perform a configured group of predefined preprocessing from multiple predefined preprocessing, wherein each of the multiple predefined preprocessing can determine, from channel information estimated by the terminal device, a different characteristic of the channel information;
a configured group of sub-encoders configured to perform a corresponding configured group of predefined encoding from multiple predefined encoding, wherein each of the multiple predefined encoding can compress the different characteristic of the channel information, based on an encoder portion of a machine learning, ML, model corresponding to the different characteristic; and
a first transmitter configured to transmit the compressed characteristics of the channel information to a network node; and
the network node comprising:
a first receiver configured to receive, from the terminal device, the compressed characteristics of the channel information;
a configured group of sub-decoders configured to perform a corresponding configured group of predefined decoding from multiple predefined decoding, wherein each of the multiple predefined decoding can decompress the compressed different characteristic of the channel information, based on a decoder portion of the same ML model corresponding to the different characteristic;
a post-processing component configured to recover the channel information from the decompressed characteristics of the channel information;
wherein one of the different characteristics of the channel information corresponds to one of:
frequency domain,
space domain,
space-frequency domain,
different antenna polarization,
different antenna sub-panel,
gain part of the channel information,
phase part of the channel information,
different frequency sub-band,
different beam,
different beamforming scheme, and
different accuracy or quantization scheme;
wherein the multiple predefined encoding is configured so that one or more of the following are satisfied:
one of the multiple predefined encoding uses a compression technique different than that used by another one of the multiple predefined encoding,
one of the multiple predefined encoding has a frequency of reporting different than that of another one of the multiple predefined encoding,
one of the multiple predefined encoding has an accuracy or quantization scheme different than that of another one of the multiple predefined encoding, and
the ML model used for at least one of the multiple predefined encoding is selectable from a teacher ML model and a configured group of student ML models of the teacher ML model; and
wherein the multiple predefined decoding is configured so that one or more of the following are satisfied:
one of the multiple predefined decoding uses a decompression technique different than that used by another one of the multiple predefined decoding,
one of the multiple predefined decoding has a frequency of feedback reception different than that of another one of the multiple predefined decoding,
one of the multiple predefined decoding has an accuracy or quantization scheme different than that of another one of the multiple predefined decoding, and
the ML model used for at least one of the multiple predefined decoding is selectable from a teacher ML model and a configured group of student ML models of the teacher ML model.

2-4. (canceled)

5. The communication system according to claim 1, wherein the terminal device is configured to select a configured group of predefined encoding from the multiple predefined encoding; or wherein the network node is configured to select a configured group of predefined encoding from the multiple predefined encoding;
wherein the configured group of predefined encoding is selected based on one or more of:
hardware capability of the terminal device,
hardware capability of the network node,
requirements of transmission scheme of the network node,
required feedback quality of the channel information,
link status between the network node and the terminal device,
channel bands used between the network node and the terminal device, and
mobility status of the terminal device.

6. (canceled)

7. The communication system according to claim 5, wherein the first transmitter of the terminal device is further configured to transmit information about the selected configured group of predefined encoding to the network node.

8-9. (canceled)

10. The communication system according to claim 5, wherein the network node further comprises a second transmitter configured to transmit information about the selected configured group of predefined encoding to the terminal device.

11. (canceled)

12. The communication system according to claim 7, wherein the information about the selected configured group of predefined encoding comprises identifiers, IDs, of the ML models used for the selected configured group of predefined encoding.

13. The communication system according to claim 1, wherein the network node further comprises a second transmitter configured to transmit, to the terminal device, a first configuration about the multiple predefined preprocessing and/or a second configuration about the multiple predefined encoding; or
wherein the first configuration and/or the second configuration are preconfigured in the terminal device.

14. The communication system according to claim 13, wherein the first configuration comprises:
IDs of codebooks used for the multiple predefined preprocessing; or
wherein the second configuration comprises one or more of:
input data types and formats for the multiple predefined encoding,
output code types and formats for the multiple predefined encoding,
reporting periods of encoded codes from the multiple predefined encoding,
life-durations of the multiple predefined encoding, and
metric for triggering refining of each of the multiple predefined encoding.

15. (canceled)

16. The communication system according to claim 13, wherein the first configuration and/or the second configuration are transmitted via one or more of:
radio resource control, RRC, signaling; and
medium access control, MAC, signaling.

17. A method performed by a terminal device, comprising:
performing a configured group of predefined preprocessing from multiple predefined preprocessing, wherein each of the multiple predefined preprocessing can determine, from channel information estimated by the terminal device, a different characteristic of the channel information;
performing a corresponding configured group of predefined encoding from multiple predefined encoding, wherein each of the multiple predefined encoding can compress the different characteristic of the channel information, based on an encoder portion of a machine learning, ML, model corresponding to the different characteristic; and
transmitting the compressed characteristics of the channel information to a network node;
wherein one of the different characteristics of the channel information corresponds to one of:
frequency domain,
space domain,
space-frequency domain,
different antenna polarization,
different antenna sub-panel,
gain part of the channel information,
phase part of the channel information,
different frequency sub-band,
different beam,
different beamforming scheme, and
different accuracy or quantization scheme; and
wherein the multiple predefined encoding is configured so that one or more of the following are satisfied:
one of the multiple predefined encoding uses a compression technique different than that used by another one of the multiple predefined encoding,
one of the multiple predefined encoding has a frequency of reporting different than that of another one of the multiple predefined encoding,
one of the multiple predefined encoding has an accuracy or quantization scheme different than that of another one of the multiple predefined encoding, and
the ML model for at least one of the multiple predefined encoding is selectable from a teacher ML model and a configured group of student ML models of the teacher ML model.

18-19. (canceled)

20. The method according to claim 17, further comprising:
selecting a configured group of predefined encoding from the multiple predefined encoding;
wherein the configured group of predefined encoding is selected based on hardware capability of the terminal device.

21. (canceled)

22. The method according to claim 20, further comprising:
transmitting information about the selected configured group of predefined encoding to the network node; wherein the information about the configured group of predefined encoding comprises identifiers, IDs, of the ML models used for the configured group of predefined encoding.

23. The method according to claim 17, further comprising:
receiving, from the network node, information about the configured group of predefined encoding.

24. The method according to claim 23, further comprising:
transmitting information about hardware capability of the terminal device to the network node.

25. (canceled)

26. The method according to claim 17, wherein a first configuration about the multiple predefined preprocessing and/or a second configuration about the multiple predefined encoding are preconfigured in the terminal device; or receiving (1116), from the network node, a first configuration about the multiple predefined preprocessing and/or a second configuration about the multiple predefined encoding;
wherein the first configuration comprises: IDs of codebooks used for the multiple predefined preprocessing; or wherein the second configuration comprises one or more of:
input data types and formats for the multiple predefined encoding,
output code types and formats for the multiple predefined encoding,
reporting periods of encoded codes from the multiple predefined encoding,
life-durations of the multiple predefined encoding, and
metric for triggering refining of each of the multiple predefined encoding.

27-29. (canceled)

30. The method according to claim 26, wherein the first configuration and/or the second configuration are received via one or more of:
radio resource control, RRC, signaling; and
medium access control, MAC, signaling.

31. A method performed by a network node, comprising:
receiving, from a terminal device, compressed characteristics of channel information which are compressed by performing a configured group of predefined encoding from multiple predefined encoding;
performing a corresponding configured group of predefined decoding from multiple predefined decoding, wherein each of the multiple predefined decoding can decompress a corresponding compressed characteristic of the channel information, based on a decoder portion of a machine learning, ML, model corresponding to the characteristic;
recovering the channel information from the decompressed characteristics of the channel information;
wherein one of the characteristics of the channel information corresponds to one of:
frequency domain,
space domain,
space-frequency domain,
different antenna polarization,
different antenna sub-panel,
gain part of the channel information,
phase part of the channel information,
different frequency sub-band,
different beam,
different beamforming scheme, and
different accuracy or quantization scheme; and
wherein the multiple predefined decoding is configured so that one or more of the following are satisfied:
one of the multiple predefined decoding uses a decompression technique different than that used by another one of the multiple predefined decoding.
one of the multiple predefined decoding has a frequency of feedback reception different than that of another one of the multiple predefined decoding,
one of the multiple predefined decoding has an accuracy or quantization scheme different than that of another one of the multiple predefined decoding, and
the ML model for at least one of the multiple predefined decoding is selectable from a teacher ML model and a configured group of student ML models of the teacher ML model.

32-33. (canceled)

34. The method according to claim 31, further comprising:
receiving information about the configured group of predefined encoding from the terminal device; or
selecting a configured group of predefined encoding from the multiple predefined encoding;
wherein the configured group of predefined encoding is selected based on one or more of:
hardware capability of the terminal device,
hardware capability of the network node,
requirements of transmission scheme of the network node,
required feedback quality of the channel information,
link status between the network node and the terminal device,
channel bands used between the network node and the terminal device, and
mobility status of the terminal device.

35-36. (canceled)

37. The method according to claim 34, further comprising:
transmitting information about the selected configured group of predefined encoding to the terminal device.

38. The method according to claim 34, further comprising:
receiving information about hardware capability of the terminal device from the terminal device.

39. The method according to claim 34, wherein the information about the configured group of predefined encoding comprises identifiers, IDs, of the ML models used for the configured group of predefined encoding; or transmitting, to the terminal device, a first configuration about the multiple predefined preprocessing and/or a second configuration about the multiple predefined encoding;
wherein the first configuration comprises: IDs of codebooks used for the multiple predefined preprocessing; or wherein the second configuration comprises one or more of:
input data types and formats for the multiple predefined encoding,
output code types and formats for the multiple predefined encoding,
reporting periods of encoded codes from the multiple predefined encoding,
life-durations of the multiple predefined encoding, and
metric for triggering refining of each of the multiple predefined encoding.

40-48. (canceled)
